(19) United States
(12) Patent Application Publication
(10) Pub. No.: US 2013/0205004 A1
(43) Pub. Date: Aug. 8, 2013

(54) Apparatus and Method to Retrieve and Store Link Results for Later Viewing

(71) Applicant: Thaddeus John Gabara, Murray Hill, NJ (US)

(72) Inventor: Thaddeus John Gabara, Murray Hill, NJ (US)

(73) Assignee: TrueMaps LLC, Murray Hill, NJ (US)

(21) Appl. No.: 13/365,339

(22) Filed: Feb. 3, 2012

(51) Int. Cl. G06F 11/00

(52) U.S. Cl. 709/224

(57) ABSTRACT

The system, a link monitor and predictor unit, monitors the user's habits, interests, attention span, etc. and analyzes the user's interest in a continuous fashion to determine the user's profile. This occurs in the background without the user's knowledge. The system automatically scans and updates the user's recently opened websites. The profile will contain the habitual websites and/or any particular categories that the user tends to view. These are the links that the system automatically downloads when the user is active looking at another website or performing some other function. The habitual system reads the user's profile and provides background instructions to the PC to start uploading the local memory (cache) with the specified website content. Then, when the user requests one of these links, it is readily available.

### CROSS REFERENCE TO RELATED APPLICATIONS

The present application is related to the co-filed U.S. applications entitled “Apparatus and Method for Comparing and Statistically Adjusting Search Engine Results”, filed on Feb. 3, 2012, and the co-filed U.S. applications entitled “Apparatus and Method for Comparing and Statistically Extracting Commonalities and Differences Between Different Websites”, filed on Feb. 3, 2012, which are both invented by the same inventor as the present application and incorporated herein by reference in their entireties.

### BACKGROUND OF THE INVENTION

The World Wide Web or internet provides information to a surfer by viewing the internet on a screen with the use of a browser. A plurality of computers and webpage servers communicatively coupled through a communication system comprise a data network, for example, the Internet. A link (such as, http://www.tyrean.com) can be entered into the browser to view the base (or home) page of a website. This base page and its sub-directories pages constitute a website. These pages can contain text, video, sounds, pictures, etc.

Search engines such as Google, Yahoo!, Bing offer fantastic search capabilities when a single term or complex Boolean search term is specified. Their search presents hundreds of millions of results to the surfer within fractions of a second. These results are ranked, segregated and presented to the surfer in counts of 10 and up to 100 results per page. The ranking of the results are used to percolate the high ranking sites to the top of the page which is presented to the web surfer for further analysis. The first one or two top results of the search results are perused by the web surfer. Selected results (or links) based on the snippet of presented data are clicked by the surfer to see if the selected link or any of the embedded links in the selected link contains the desired information. One problem is that the surfer typically finds that several of the clicked links do not pertain to the desired interest of the surfer so the surfer enters in a new search term to better hone in their desired web search. This causes a discontinuity between the first and second search attempts.

Another problem can occur in the second search results, is that several links that have already been inspected during the first search will be shown again. The only control to the surfer in displaying the links in the returned search results is through a judicially designed search term which is limiting the flexibility of the web search.

U.S. Pat. No. 7,421,432 (Hoelzle et al.) issued on Sep. 2, 2008 describes a hypertext browsing assistant that does not require that the user leave the document the user is currently viewing. Hoelzle describes how the browsing assistant retrieves multiple links selected by the user. The rank of the links is determined by assigning scores to the links or alphabetizing them. U.S. Pat. No. 6,285,999 (Page-1) issued on Sep. 4, 2001 provided a system for ranking document in a linked database.

U.S. Pat. No. 7,437,351 (Page-2) issued on Oct. 14, 2008 searches in response to Internet-based search queries using search engine and an electronic database. U.S. Pat. No. 7,716,225 issued on May 11, 2010 to Dean et al. generates a model based on feature data relating to different features of a link from a linking document to a linked document and user behavior data relating to navigational actions associated with the link.

U.S. Pat. No. 7,827,181 (Petriuc) issued on Nov. 2, 2010 measures a click distance as the number of clicks from a first document to another document. Specialized words are included in the locally stored inverted index. U.S. Pat. No. 7,853,583 (Schachter) issued on Dec. 14, 2010 generates search results comprising web documents with associated expert information.

The above cited patents have addressed certain aspects of the previously mention problem. The embodiments of the invention are provided in this document that overcomes this problem and provides a new approach to analyzing different aspects of searching the web.

### BRIEF SUMMARY OF THE INVENTION

One embodiment of the invention allows an interne user (surfer) to perform a search on the web and add some features to the web search that can provide the user with an additional level of control for searching the web. The statistical results include a content of terms between the selected pages that can be used as a basis to further conduct a new search study. The statistical results can be formed from a cross-statistical analysis between two webpages or a self-statistical analysis of a single webpage. A certain portion of the result can be used to mask (negate) the search results, while another portion can be used to direct the search engine to seek out the performed terms or the distribution of these preferred terms. In addition, the statistical results can be used to analyze each selected page so the user knows the content and statistics of the content of pages being viewed. This information can be used to select new links by either viewing the statistical results, the link or both the statistical results and link. The selected links that are of “interest” to the user can be checked to include the link for further analysis by the user or system or serve as a seed to create more search terms.

For most conventional searches, the aspects of the previous search results are not fully leveraged against the new search result that is attempting to hone in on the desirable link with information the user is interested in. Several links have been selected and viewed in the previous search; however, the new search results usually show these same links again. An inventive embodiment is to block showing these previously viewed links in any of the newer search results. Alternatively, small icons can be placed on the display screen indicating previously of “interest” links.

Another embodiment provides the presentation of the statistics of a webpage as the result of a search. By hovering the cursor over the link of one of the results, statistics regarding the search terms and related terms are presented to the user in a graphical form. One example is displaying the number of occurrences of the selected and related search terms in a new histogram; another is the position of search terms and related terms in various sections of the page such as headings, titles, captions, etc. These graphical results characterize the flavor of a desired webpage. The desired or reference webpage, which was selected at an earlier time by the user, is used as a reference histogram. The new histogram can be superimposed over the desired histogram to help select or determine if the new webpage is matching the user's interest. Anytime a newer page is opened, the graphical results can be viewed to see how close the newer web page matches the flavor of the desired web page.

Another embodiment allows the system or user to select the statistics from a selected page, then use the statistics as a seed to compare the selected page statistics against other webpages. The statistics of all results can be graphically displayed, if desired, in a popup window. This embodiment allows the user to determine if certain webpages are similar to the web page selected earlier by the user. These results can be analyzed for the determination of a category so an appropriate search expression term or statistical mask can be developed. The search expression term can be a Boolean expression or a statistical mask. The search expression term or statistical mask is used as a seed to start another search moving closer to the final target or desired goal of finding the best website to fit the user's interest. The statistical mask is a statistical collection of content on a webpage or between webpages. The content can include user selected terms, videos, pictures, links, advertisements, all words in the document, words selected in a previous search result, audio clips, etc. The statistical mask can provide counts of objects, terms, occurrences, links, items the user is not interested in, etc.

Another embodiment allows the system or user to scan the statistics of several pages and compare and analyze the results for search term commonality. The statistics of all results can be graphically displayed if desired. This embodiment allows the user to determine how strongly tied the scanned data content of two different webpages are to each other. These results can be analyzed against each other to generate common search terms, a final histogram, and how this histogram compares to the reference histogram. Such information allows for the determination of a category so an appropriate expression term or statistical mask can be developed. The expression term or statistical mask is used to start another search moving gaining additional information on the final target or desire goal of finding the best website to fit the user's interest.

Another embodiment allows the system to scan and update recently opened websites. For instance, on a news website, the user may enjoy the tech and science tab. The system monitors the user's habits, interests, attention span, etc. and analyzes the user's interest in a continuous fashion to determine the user's profile. The profile will contain the habitual websites and/or any particular categories that the user tends to view. Since the user enjoys the tech and science sites, the directory address would be saved along with these categories of the user's interest. Then, when the user logs back on to the network, the habitual portion of the system reads the user's profile and provides background instructions to the PC to start uploading the local memory (cache) with the specified website content.

Hoelzle et al. describes various methods of searching document using terms and a browser assistant. However, remains silent with producing, using or analyzing the statistical results (as defined below) of a number of links and presenting these statistical results to the user in a graphical format. The user uses this graphical information to help the user determine different search terms. In this embodiment of the invention, the user plays a role in determining the direction of the search by reviewing the statistics of the previous search results. These statistical results are used by the user to further regulate the search. The statistical results can be used to create a statistical mask to select new websites. A histogram of a desired web page (represented by the statistical mask) is compared to other new links of websites. For example, those websites that have a similar distribution that matches the mask would be of interest to the user.

### BRIEF DESCRIPTION OF THE DRAWINGS

Please note that the drawings shown in this specification may not be drawn to scale and the relative dimensions of various elements in the diagrams are depicted schematically and not necessary to scale.

FIG. 1a shows a network of comprising a laptop coupled to servers via the internet.

FIG. 1b depicts a search engine page pointing to search results.

FIG. 1c presents a more detailed block diagram of the network of FIG. 1a.

FIG. 2a illustrates a block diagram of the server or search engine.

FIG. 2b shows a search page with links to several pages illustrating this inventive technique.

FIG. 3a shows a Google search result of a search for houses.

FIG. 3b shows a web page of one of the links from the search results of FIG. 3a.

FIG. 3c presents a Bing search result of a search for houses.

FIG. 3d illustrates a Yahoo! search result of a search for houses.

FIG. 4a depicts a flowchart in accordance with the present invention.

FIG. 4b presents a flowchart comparing two or more pages in accordance with the present invention.

FIG. 5a illustrates a Google search result of a search for houses illustrating this inventive technique.

FIG. 5b a web page of one of the links from the search results of FIG. 5a illustrating this inventive technique.

FIG. 5c-d shows a Bing search and a Yahoo! result of a search for houses illustrating this inventive technique.

FIG. 6 shows a flowchart using manual selection illustrating this inventive technique.

FIG. 7 depicts the apparatus of comparing web pages illustrating this inventive technique.

FIG. 8 shows the network a flowchart comparing two or more pages in accordance with the present invention.

FIG. 9 illustrates the apparatus of selectively comparing web pages illustrating this inventive technique.

FIG. 10 shows a scan and select compare of pages illustrating this inventive technique.

FIG. 11a depicts a scan and compiles the comparison of pages using statistics illustrating this inventive technique.

FIG. 11b illustrates the distribution of data for different pages illustrating this inventive technique.

FIG. 11c shows a graphic representation of search results against the distribution of FIG. 11b illustrating this inventive technique.

FIG. 11d depicts a graph of term occurrences of desired and undesired terms illustrating this inventive technique.

FIG. 11e shows an example of term distribution in the search of the term “patent” illustrating this inventive technique.

FIG. 12a depicts a link from a search result illustrating this inventive technique.

FIG. 12b illustrates a node graph of FIG. 12a in accordance with the present invention.

FIG. 12c shows the backward links of this inventive technique.

FIG. 12d shows the first two levels of forward links of this inventive technique.

FIG. 12e shows the first three levels of forward links of this inventive technique.

FIG. 13a depicts two links from a search result illustrating this inventive technique.

FIG. 13b illustrates a node graph of two links in accordance with the present invention.

FIG. 13c shows the backward links of this inventive technique.

FIG. 13d depicts the first level of forward links illustrating this inventive technique.

FIG. 13e shows the first two levels of forward links illustrating this inventive technique.

FIG. 13f depicts the first three levels of forward links illustrating this inventive technique.

FIG. 14a-b illustrates a flowchart of storing links into local memory in accordance with the present invention.

FIG. 15a depicts a system to monitor a user's use of the search engine in accordance with the present invention.

FIG. 15b illustrates flowchart to monitor a user's use of the search engine illustrating this inventive technique.

FIG. 16a shows a block diagram of a computer illustrating this inventive technique.

FIG. 16b shows a block diagram of a computer with additional memory illustrating this inventive technique.

While the invention is altered to various modifications and alternative forms, specifics thereof have been shown by way of examples in the drawings. It should be understood, however, that the intention is not to limit the invention to the particular embodiments described and shown.

### DETAILED DESCRIPTION OF THE INVENTION

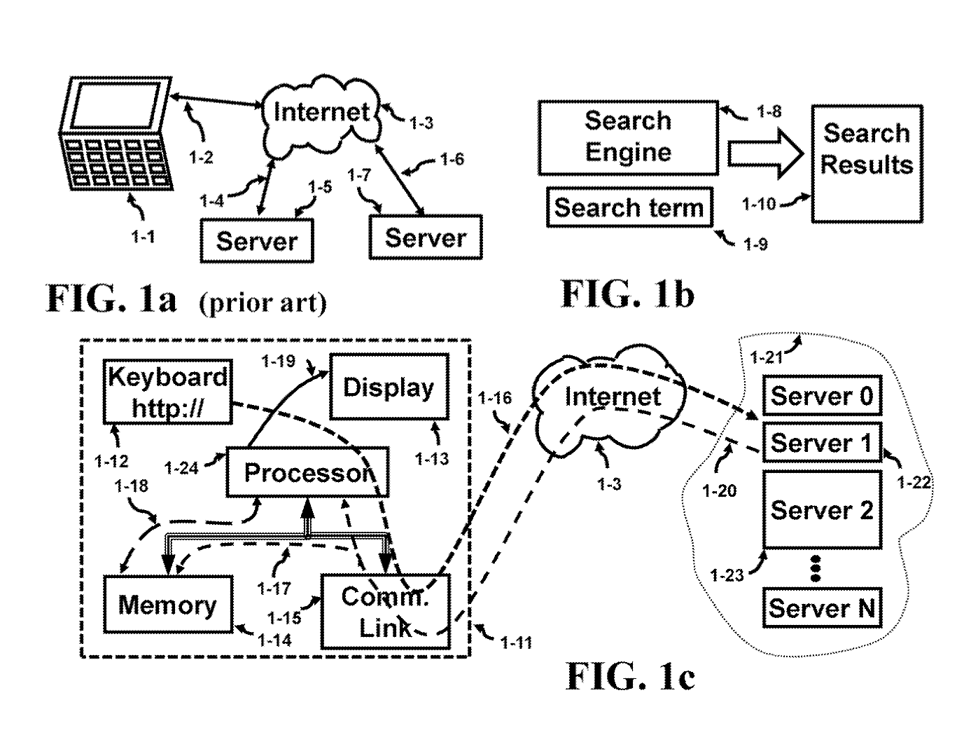

FIG. 1a illustrates a network where a computer 1-1 is connected 1-2 to the Internet 1-3 and servers 1-5 and 1-7 through interconnects 1-4 and 1-6, respectively. This network is very simplistic but is a representative of a rudimentary type of an Internet network. A user of the computer can perform a search of the Internet through a browser mounted on the computer by using a search engine. FIG. 1b depicts a very high level illustration of a search engine 1-8 in a server with a search term box 1-9 entered on the computer that provides search results 1-10 on a return page.

FIG. 1c illustrates a little more depth into what's inside the network shown in FIG. 1a. In the computer 1-11, the processor 1-24 is coupled to the memory 1-14 and the communication link 1-15 through a common bus 1-17. In addition a keyboard 1-12 allows input entry while a display 1-13 presents results. Other typical components such as; a mouse, GPS, touch screen, voice recognition, power supply, etc. have not been illustrated to simplify the diagram and are items known in the art. After typing and entering data via the keyboard, this information flows along the dotted line path 1-16 through the processor onto the bus into the communication link through the Internet and to several servers 1-21. In particular, the information is submitted to the server 1-22. The server 1-22 in return, responses along the dotted line 1-20 through the Internet back to the computer 1-11 through the communication link 1-15, the processor 1-24 and to the display 1-19. Information is stored in the memory 1-14 via the dotted path 1-17. In addition, the processor interacts with the memory through the path 1-18 of the bus and controls the display through path 1-19. The Internet 1-3 may couple to a bank of servers 1-21. The server 1-23, for instance, may also provide search engine capability.

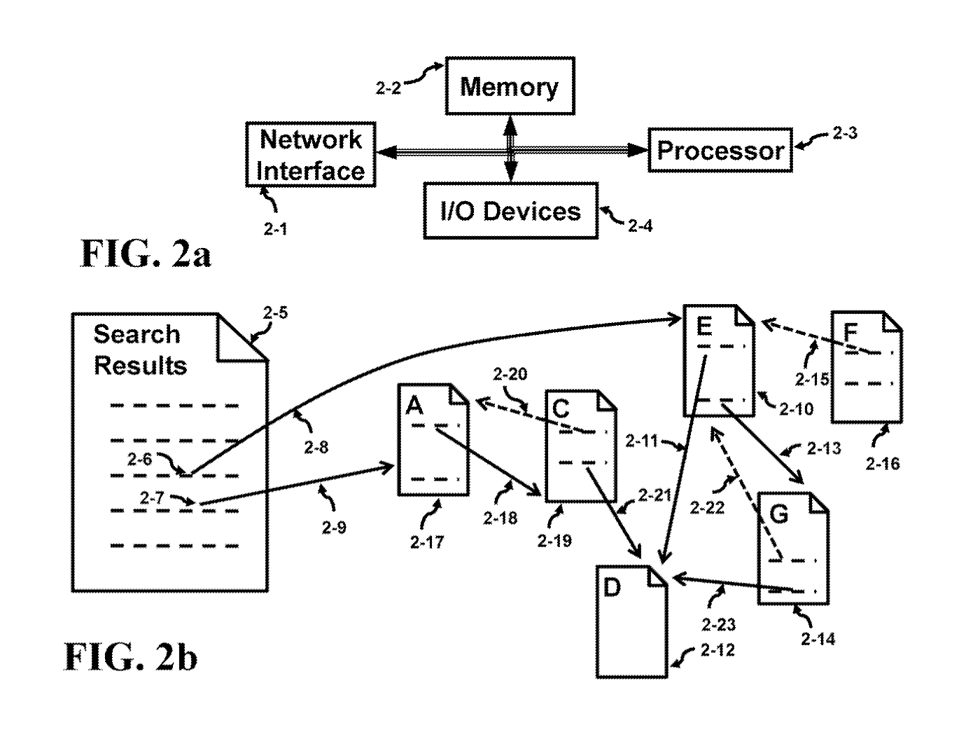

FIG. 2a illustrates the block diagram of a server that interfaces to the Internet 1-3. The server contains a memory 2-2, a processor 2-3, and I/O devices 2-4 that interfaces to the network interface 2-1 which couples to the Internet. The block diagram for this interface is very rudimentary but illustrates some of the basic components that are necessary to interface to the Internet.

FIG. 2b depicts a webpage containing search results 2-5. Inside of the webpage, there are two hyperlinks (called links) 2-6 and 2-7. Hyperlinks (or links) are embedded in a search page result and provide the address of a different page on the Internet. Each of these links if clicked will access the Internet to present that particular page. The link 2-6, if clicked, will follow the forward path 2-8 to the page E 2-10. The result page E also has links a forward link 2-11 going to page D 2-12. A second link on page E provides the forward link 2-13 to page G 2-14. There is also a backwards link 2-15 (shown as dotted) from page F 2-16 that points back to page E 2-10. Page G, also has a backward link 2-22 to page E. Finally page G 2-14 has a forward link 2-23 to the page D 2-12.

Different web addresses and contents are at different levels in the link starting from the homepage. The sub-page links are at the 1^{st}, 2^{nd}, 3^{rd}, etc. levels. The forward link is the path is moving away from the homepage and the level of the link increases. The reverse link is the path is moving towards the homepage where the level of the link decreases. The horizontal link is when the level that the path moves on the same level between two sub-pages.

Returning back to the initial search results page 2-5, if the link 2-7 is clicked, the forward link 2-9 points to page A 2-17. Page A has a forward link 2-18 that goes to page C 2-19. A backwards link 2-20 from page C 2-19 goes back the page A. Page C 2-19 has a forward link 2-21 to page D 2-12. Between these two separate links 2-6 and 2-7 on page 2-5, the forward link structure intersects at pages D 2-12 causing these two paths to have some common links.

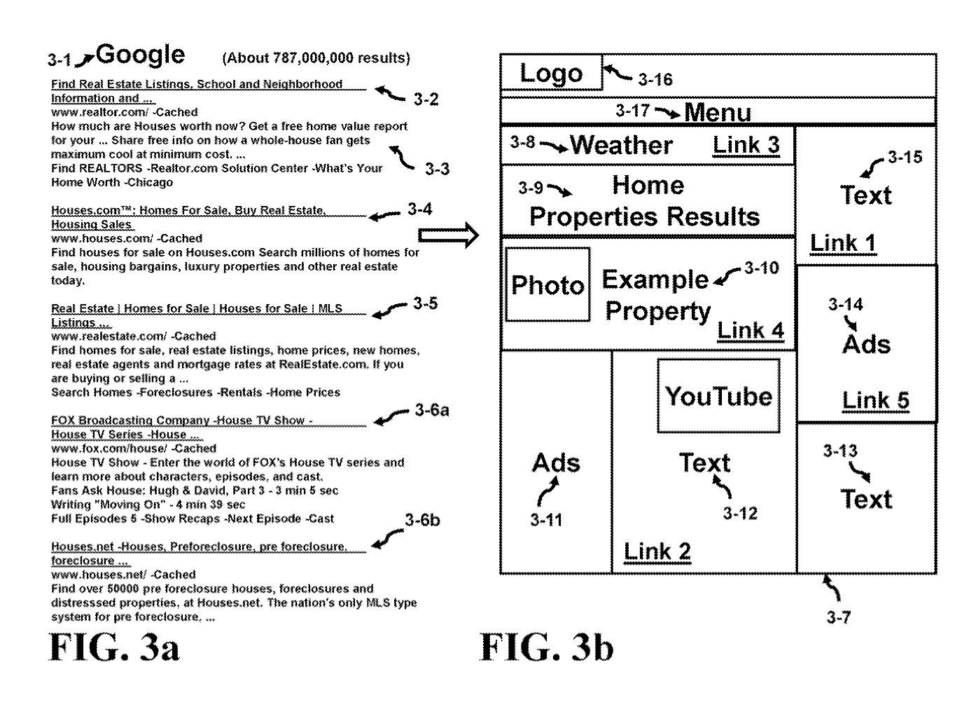

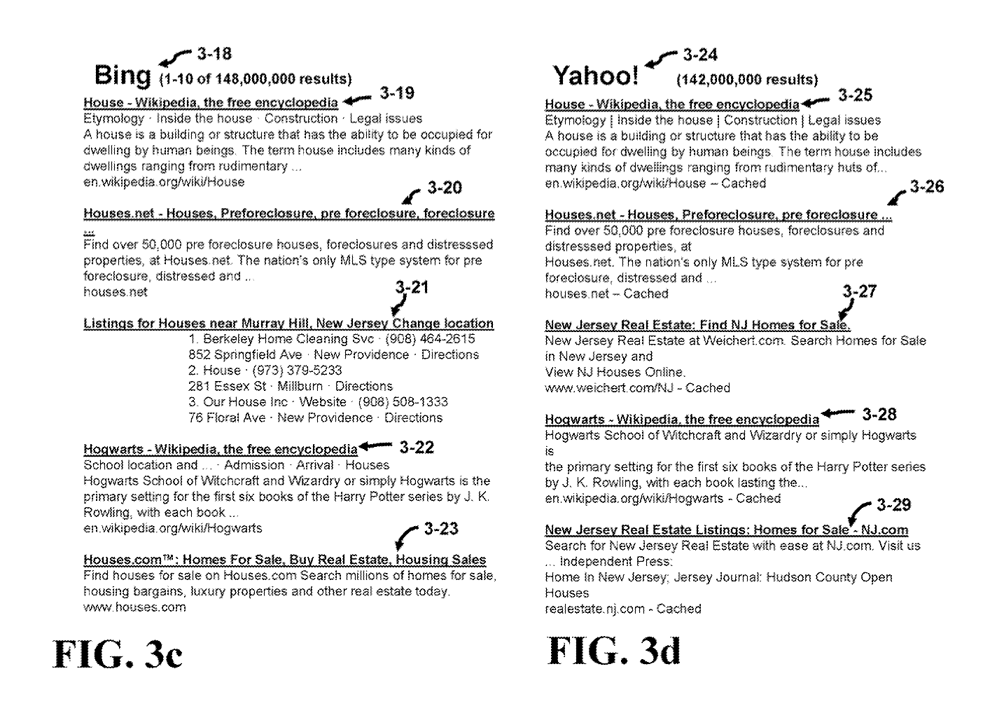

FIG. 3a illustrates a page of a Google search engine result 3-1 for the word “houses” which displays 787,000,000 results. Only a few of the top results are shown. The advertised webpages (pages paid to rank high in a search) typically are shown above these results and/or are shown in a column on the right side. In addition, the column along the left-handed side of these results is not illustrated to simplify the diagram. This search result is a query due to the word “houses.” This search result page displays a plurality of links. The first link 3-2 rated at the top and if clicked would bring you to the webpage www.realtor.com. Below the first link 3-2 is a body of text called a snippet 3-3 to provide an idea of what this particular link may contain? Other links are illustrated at 3-4, 3-5, 3-6a and 3-6b.

If the link 3-4 is clicked, a webpage 3-7 similar to what is illustrated in FIG. 3b is presented and has been segregated into blocks. This page, which is one of the many pages at the website, has some general features or properties that are usually shared among all webpages. Typically there is a logo block 3-16 and a menu block 3-17. Some sites may have a weather block 3-8 and can include a link 3. Since this is a site that came up with the search term of “houses,” the webpage 3-7 provides information on house in the home properties results block 3-9 on this webpage. Often, there'll be an example property 3-10 that may present the photo of the home as well as giving a link 4 that would provide more data on this house. Several blocks of the webpage may contain ads (advertisements) as 3-11 and 3-14 where the latter ad contains a link 5. Text is presented in three blocks of the webpage. The ads are in block 3-13, block 3-15 that also contains a link 1, and block 3-12 that contains link 2 and a YouTube video. The layout or makeup of a typical webpage result can be more or less complex. The webmaster, who created this webpage, may have adjusted sections of the page according to a content software tool like Joomla or constructed the page from scratch using other software tools based on HTML (Hyper Text Markup Language).

In FIG. 3c, the search engine Bing 3-18 also provides the search results for the term “houses” which displays 148,000,000 results. Several links 3-19 through 3-23 are illustrated. In FIG. 3d, the Yahoo! Search 3-24 which displays 142,000,000 results provides the link results 3-25 through 3-29. Again for these search results, the ads or any information along the top, right column or left column has been removed to present only the top 5 search results for the term “houses.” if any of these links are clicked, a page with block like features similar to that of FIG. 3b would be illustrated.

Note that in the search results of FIG. 3c and FIG. 3d the fourth link calls for “Hogwarts . . . ” which has something to do with Harry Potter. The statistics of the “Hogwarts . . . ” page be used as a mask to eliminate any webpage that has characteristics of the mask. Thus, in the second, third, . . . , iterations of the search, the “Hogwarts . . . ” site or anything similar to it will not show up. In addition, the user can request (checkboxes) to refrain from showing a link that already has been viewed by the user. Any webpage that has been viewed by the user has a checkbox that requests if future searches refrain from showing this link. A textbox requests the user to rate the site from a 0-9 where a 0 is low, and 9 is high.

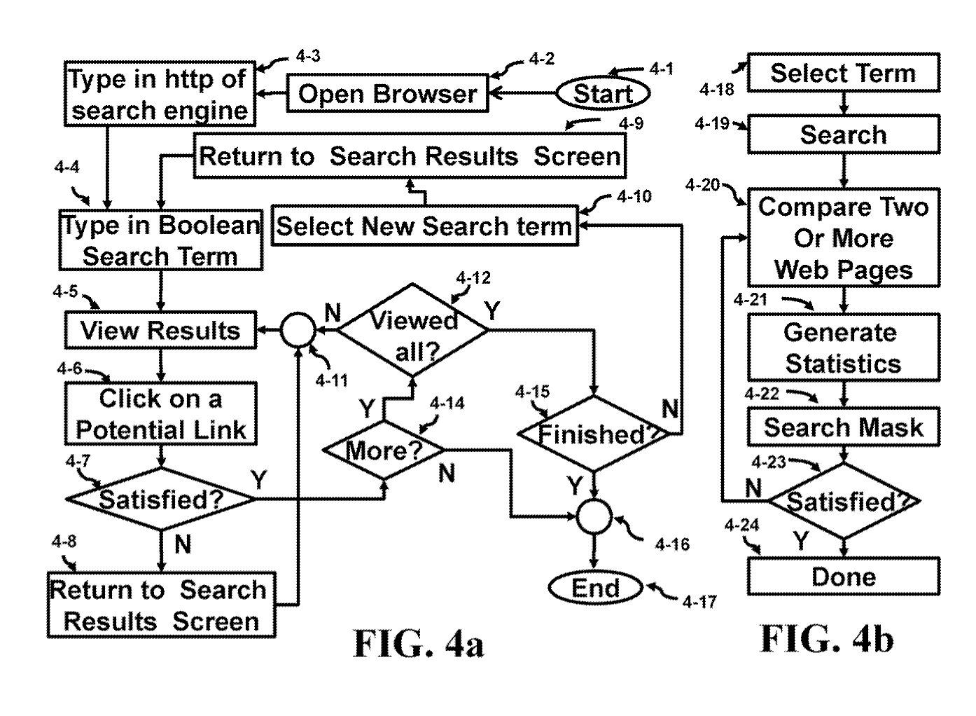

The flowchart illustrated in FIG. 4a presents a procedure when using a search engine. At start 4-1, a browser is clicked open 4-2. The HTTP (Hypertext Transfer Protocol) of the desired search engine is typed in the address bar of the browser 4-3 and a simple or complex Boolean search term is entered into the search engine 4-4. When the search engine returns the results 4-5, the user clicks on a potential link 4-6 and previews the webpage. In the decision box 4-7, one determines if they're satisfied with the results. If not, the link is marked as an un-desirable link and the user moves to box 4-8 which returns to the search engine results screen and allows the user to select a different link. On the other hand, if one was satisfied, then the decision box 4-14 week requests if the user wants more information. If not, the user proceeds to the union 4-16 and exits the program 4-17. If the user decides to see more 4-14, the user is presented with another decision box 4-12 requesting if all desired links have been viewed. If not, proceed to union 4-11 and continue reviewing results 4-5. However, if all desired links have been viewed then the next decision block 4-15 requests if the user is finished. If so, then the user exits at the end 4-17. If the user is not finished, the user decides to select a new search term 4-10 returning the user to the search results screen 4-9 so that the user can type in a new search term 4-4. Control flow proceeds as before. However, the new search term 4-10 will be determined by the user. The selection of the new search term will typically be narrowed with another term being added by the user.

An inventive embodiment of providing search engine results is illustrated in FIG. 4b. The first step is for the user to select a search term 4-18, which is entered into the search engine 4-19. The search engine returns with numerous page link results and the user selects two or more links or webpages from these results 4-20. After the selection of these two or more selected links, either the search engine or the local computer generates statistics 4-21 between the selected webpages or links. The statistical results compares the selected pages and presents to the user a chart of similar terms related to the terms that were provided to the search engine 4-19. This chart is used by the user to generate a new search mask 4-22 that looks at the statistics of a page and compares those statistics to the chart. This way the user's desire for the selected pages becomes more tailored to the target. This new search result provides numerous page links that more closely match the user's intended search. The results are presented to the user. The user reviews the selected links and determines in first decision block 4-23 if the user is satisfied with the results, and if so, the user is done 4-24. But if the user decides to further hone in (target) on his search, the user can return to block 4-20 and again compare at least one new webpage with a previously selected webpage. The user can then continue the statistical search process. Note that in this flowchart, the user interacts with the search engine to hone in (target) the desired webpage that will be of interest to the user.

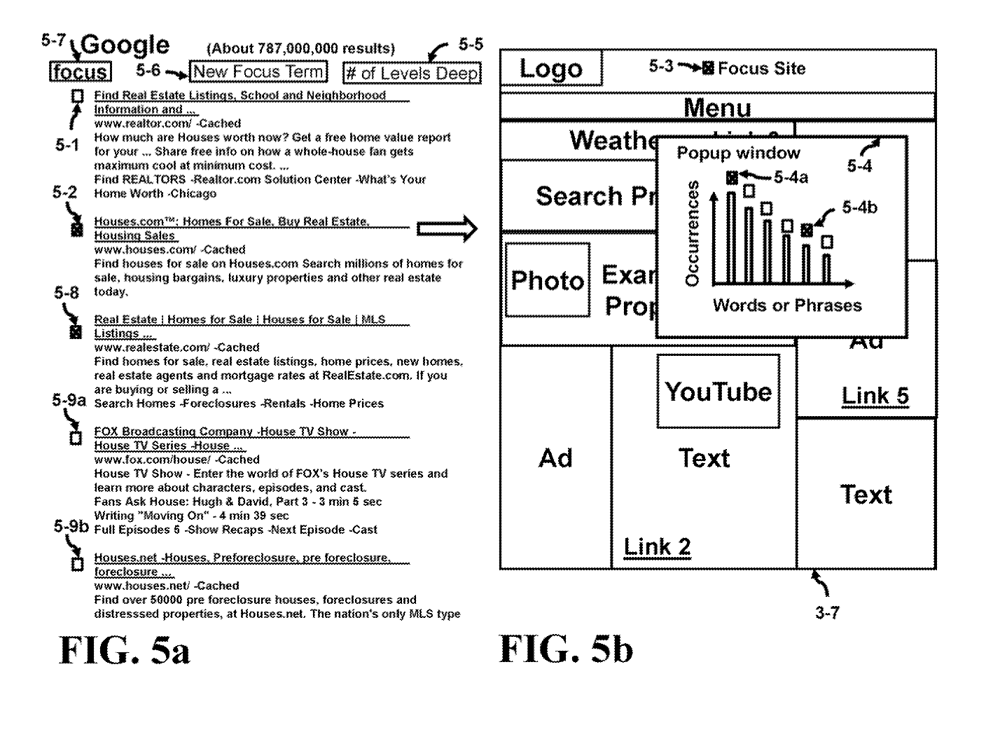

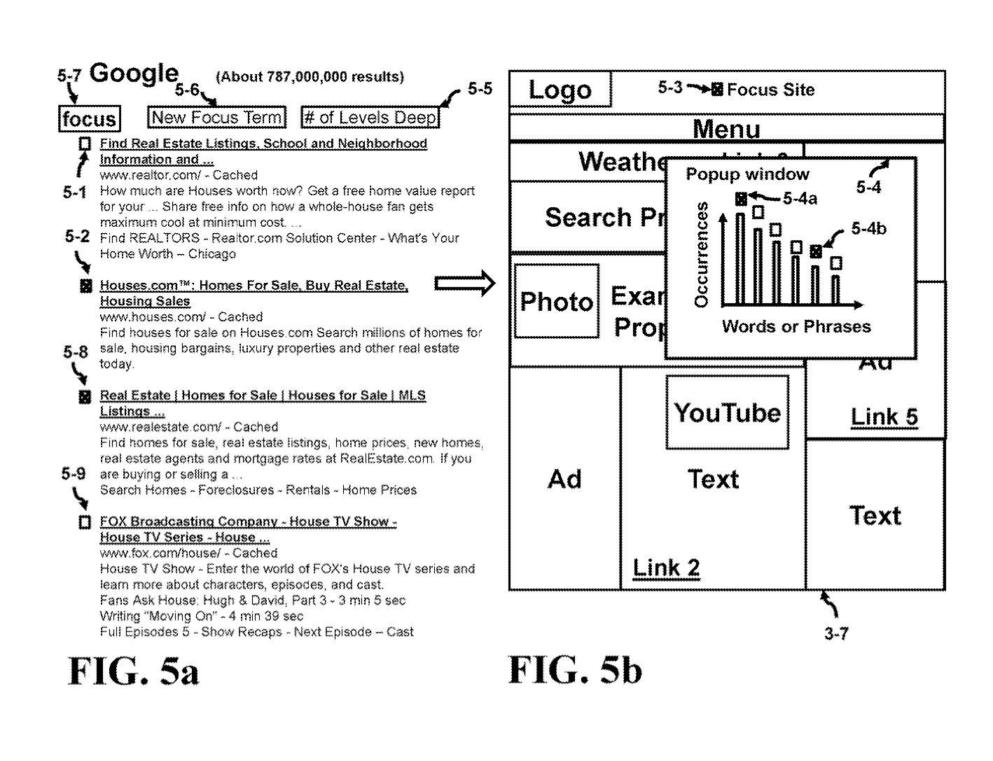

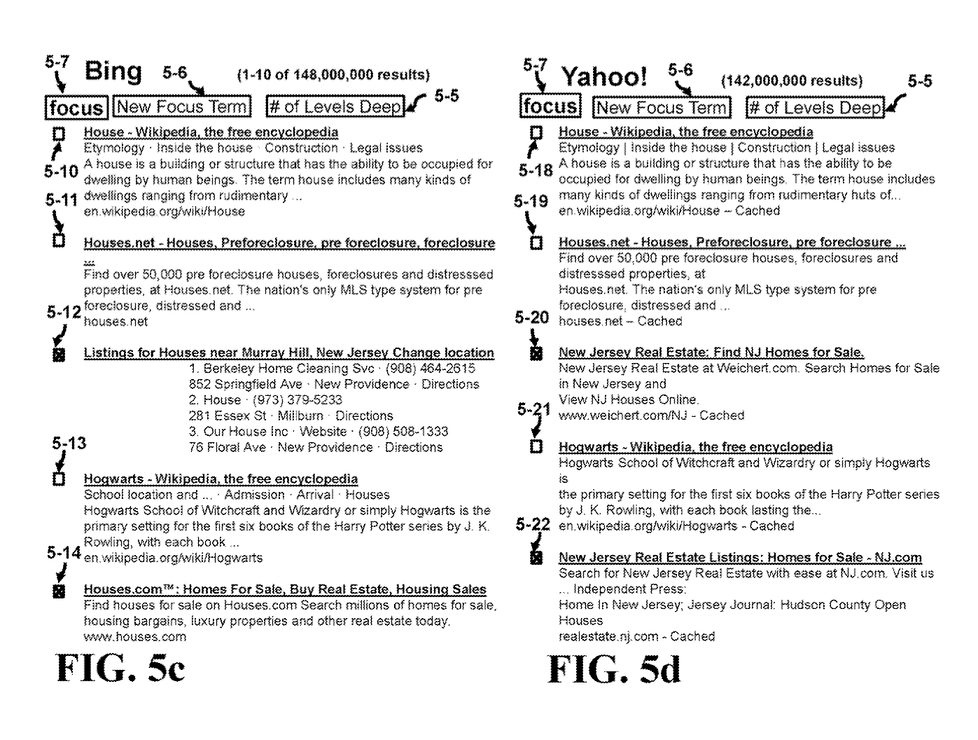

An example of a Google search page with a few inventive features is presented in FIG. 5a. The inventive features are along the top, along the left side and along the left side; these features can be located anywhere on the display screen. The features can be exhaustive in details or simplified to just requesting the “new focus term.” This search result page displays a plurality of links. The check boxes are 5-1, 5-2, 5-8 and 5-9 and can be clicked to select particular links. There can be other checkbox or textboxes to fill to narrow the search. Once the links are selected, these links becomes a user selected links. Two of the check boxes 5-2 and 5-8 have been selected. Besides this one checkbox, there can be other checkboxes that can be selected by the user to identify if this link should show up in future searches. Or if the link did not meet up with expectations, a different checkbox can be checked to prevent showing this link during any of the derivative searches. A derivative search is the inventive form of iterative searching by using the statistics results of the last search to help determine the characteristics of the statistics results of the next search to hone in on the final answer. In a derivative search the search is performed iteratively using the previous search results. In some cases, the components of the previous search can be blocked from being used in the next search, for example, previously viewed links can be selected by the user to not show up in future searches. Along the top are is the “focus” button 5-7 and two new entry windows the “new focus term” 5-6 and the “# of levels deep” 5-5. The new search term or “new focus term” is entered in the box 5-6 to more selectively search the checked boxes that were selected along the left hand side. The “# of levels deep” 5-5 allows the user enter the number of forward links that the user decides to view. For example, if the user enters “3” in 5-5 then the user will view only those links and sub-links that forward to a first, second, third level link. In addition, the “focus” button 5-7 is be pressed to initiate the comparison or search depending on the links with selected checkboxes by the user, the user selected links, and data entered into the boxes to provide a second web search. Any links that were previously viewed by the user in the previous search are either; a) marked in a different hyper-text color; or 2) not presented to the user in the next derivative web search.

Another inventive embodiment is illustrated in FIG. 5b. If the link related to 5-2 is clicked, the webpage in FIG. 5b is illustrated which is very similar to the webpage 3-7. A check box 5-3 called the “focus site” is shown within this link. However, this checkbox could also be presented just outside the contents of the browser window itself so that the webpage 3-7 would not be altered. Once the check box 5-3 is selected, a pop-up window 5-4 allows the user to view details of the current webpage. The statistical results can be presented on any display terminal where a popup window is one example. The statistics can be presented in several formats: charts, tables, graphs, histograms, etc. For example, a histogram presented in popup window 5-4 presents words closely matching the initial focus search term. The presented results enter additional criteria to limit the search and/or rate the search. For example, check boxes can be provided above each word or term where these checkboxes can be checked to eliminate these words in the next focus search. In addition, the checked boxes can be Boolean manipulated to perform “AND,” “EXOR,” “NOT” and other complex functions. Although not shown, the popup window can show the number of levels deep the user wants to make the search, where separate entries can be added if the depth is backwards only, forwards only, or both. The popup window can include a rating system to rate the website page presented to the user. Once the user returns back to the search page, the checkbox at 5-2 can be filled to indicate whether the link is desirable or not. The user can enter another link from the initial search and enter in values for that popup window 5-4. The popup window will have a site rate entry checkbox that can leverage the site's position in the final search. The user can return back to the initial search of FIG. 5a and enter a “new focus term” 5-6 that can be currently selected by the user or selected previously in a popup window. The user would then hit the button “focus” 5-7 to see the new results of the search.

The search results for Bing and the Yahoo are provided in FIG. 5c and FIG. 5d. FIG. 5c again shows the “focus” button 5-7 a “new focus term” 5-6 and the “# of levels deep” 5-5 along the top border. Along the left border are the checkable boxes 5-10 through 5-14. Other presentation schemes are possible as mentioned earlier. The Yahoo page in FIG. 5d illustrates a similar layout. Along the top is the “focus” button 5-7, the “new focus term” 5-6 and the “# of levels deep” 5-5 entries. Along the left side are the checkboxes 5-18 through 5-22. The actual location of these buttons and data box entries can be either embedded within the search window results themselves or a part of the browser window layout.

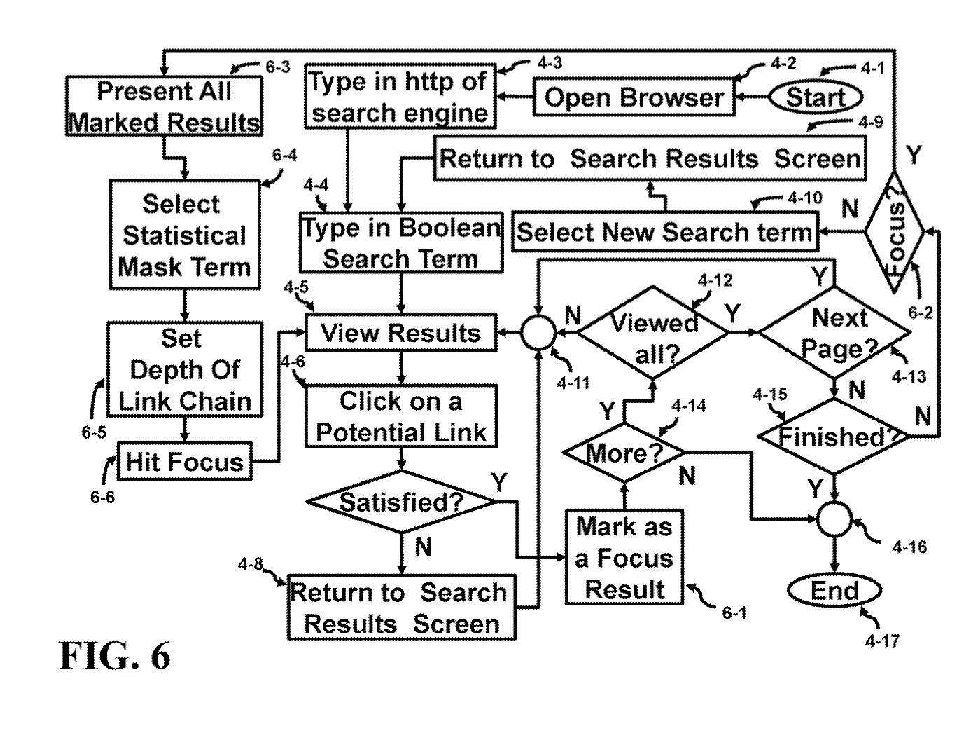

FIG. 6 illustrates the focusing aspect into the flowchart which is similar to the flowchart given in FIG. 4a. At start 4-1, a browser is clicked open 4-2. The HTTP (Hypertext Transfer Protocol) of the desired search engine is typed in the address bar of the browser 4-3 and a simple or complex search term is entered and entered into the search engine 4-4. When the search engine returns the results 4-5, the user clicks on a potential link 4-6 and previews the webpage. In the decision box, the user can determine if they're satisfied with the results, a checkbox can be selected to indicate that this webpage is desirable. If not, the user moves to box 4-8 which returns to the search engine results screen and allows the user to select a different link.

The new additions in FIG. 6 include the condition if after viewing a link on the search page and one is satisfied, then this page is marked as a focus result as in 6-1. On the other hand, if one was satisfied, then the decision box 4-14 would request if the user wants more information. If not, this link is an un-desired link and the user proceeds to the union 4-16 and exits the program 4-17. Otherwise, if the user decides to see more information 4-14, the user is presented with another decision box 4-12 requesting if all desired links have been viewed. If not, proceed to union 4-11 and continue reviewing results 4-5. However, if all links on that page have been viewed then the next decision block requests if the user wants to see the next page 4-13. If so, the results are viewed 4-5, and if not, then the next decision block 4-15 requests if the user is finished. If so, then the user exits at the end 4-17. Otherwise, if the user is still not finished finding an answer to his search category, the user can focus as illustrated in decision box 6-2 can either allow a selection of the new search term or it may present all the marked results so far as illustrated in 6-3. If the user agrees to focus 6-2, then the checkboxes (See FIG. 5a, for example) are marked automatically with data collected during the user-interface interaction where the user can un-check any checkboxes, if desired the search result page is presented to the user with the checkboxes marked indicates which links potentially present good results 6-3. At this point the user can select the statistical mask 6-4 as well as setting the depth of the link chain in 6-5. Other parameters mentioned earlier such as only forward links or only backward links or both can also be incorporated into the decision list (not illustrated). Once completed, the focus button 6-6 is depressed to provide a new list of results. Control flow proceeds as before.

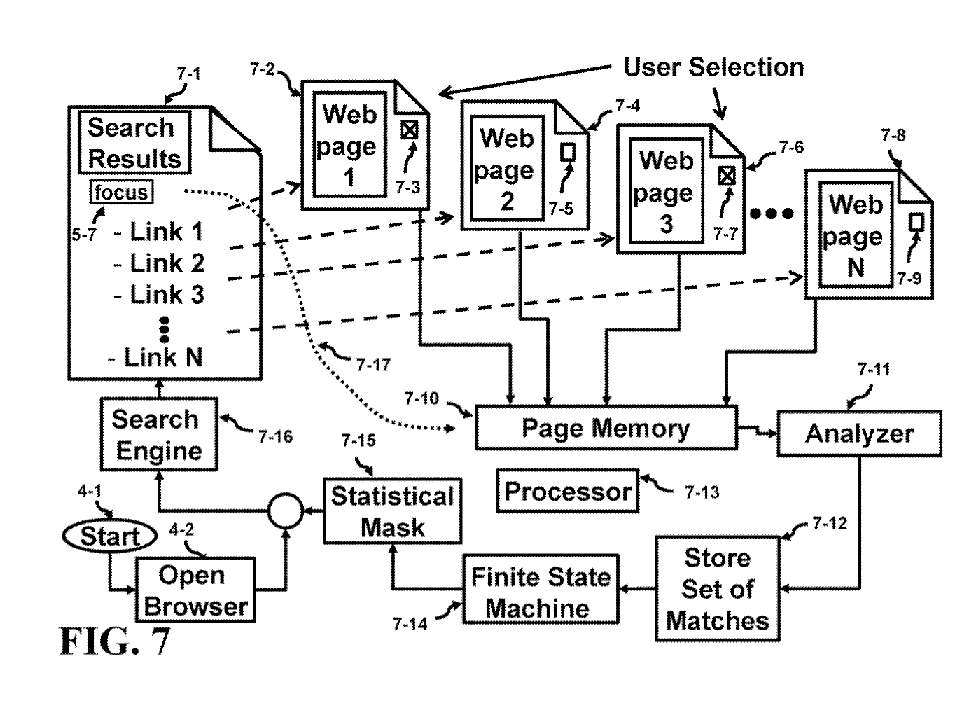

FIG. 7 illustrates an inventive embodiment that presents how the various links for a given webpage 7-1 on a browser can be viewed and then selected if desired for further analysis. Once one of the various links is selected, that link becomes a riser selected link. At start 4-1, a browser is clicked open 4-2. The HTTP (Hypertext Transfer Protocol) of the desired search engine is typed in the address bar of the browser and a simple or complex search term 4-4 is entered into the search engine 7-16. The search engine 7-16 provides the results as the webpage 7-1. The interesting links can be clicked and viewed on the browser. For example, link 1 is shown on the browser presenting the results as webpage 1 7-2. A checkbox 7-3 can be checked if this link provides interesting results to the user. The checkbox 7-3 can be within the browser or potentially within the webpage itself and can be either checked or un-checked by the user. In addition, there can be other checkboxes in the link but have not been depicted. Filling the user selection checkbox as shown in 7-3 indicates that this page is of interest to the user and should be used for further analysis. After returning back to the search result page of 7-1, the user clicks on the next link to provide the user a browser view of webpage 2 7-4. In this case, the user selection checkbox 7-5 is not selected. This page does not have sufficient interest for the user. After returning back to the search result page 7-1, the user selects the next link 3 to provide the user a browser view of webpage 3 7-6. The user selection checkbox 7-7 was selected by the user after perusing the webpage 3 7-6 since this particular page is also of interest to the user. Returning back to the search results 7-1, the user looks at the last link on the page and opens up the browser to view this page webpage N 7-8. The user does not feel that this page contains pertinent data, does not select selection checkbox 7-9 and returns back to the webpage 7-1. Although not illustrated, at this point, the user can focus their search by entering in data such as a new focusing term, the number of levels deep, only backward links, only forward links and a host of other user or set parameters that can enhance locating a particular piece of information from the Internet. Once the focus button is activated, the control moves along path 7-17 to store results in page memory 7-10. Similar issues have been addressed in FIG. 6 and are comparable.

The focus button 5-7 in FIG. 5a is pressed after the entry of all desired parameters is made and the selected webpages are entered in the page memory 7-10 along path 7-17. The data content of the webpages comprises the data portion (text, photos, etc.) and structure portion (font, position, location, etc.). These data contents of a webpage can be stored, transported and re-generated into the original webpage. The data content can also be statistically evaluated to analyze the webpage and use these results to form better search terms. The processor 7-13 controls the process flow of further analysis. Those pages having the filled checkbox are extracted and are sent to an analyzer 7-11. The analyzer looks for matches, logical masking, union or intersection between the data content of the selected webpages. The analyzer generates matched data sets and starts to compile various statistics of the words that happen most often, words that may be in the particular heading on the webpage, words that are associated with other similar words, words that are opposite to the meaning of what one is search and, thereby developing an analysis between the selected pages of the commonality and differences that the selected pages share. The matched data sets can be generated by the union and intersection of the data content of the selected webpages. This commonality and differences are the aspects which will be used to fine tune the search characteristics after focusing. This type of search constraint adds a new dimension to searching on the Internet. The user selects particular webpages that are of interest to the user and these particular webpages are used against each other to determine the user's interest in the desired type of pages. This data is collected, combined and analyzed to generate a statistical mask more in line with the pages already viewed and selected. This mass of data can then be presented on the web to others pages until there's a similar match with characteristics that are in the approximate range of the comparison performed of the previously selected pages. Thus, the commonality and differences between pages can be fully utilized and extracted to perform further searches such that another mode of search capability is available to the user. Finally, the words that are opposite to the user's meaning can be selected as the words in the search term that you would like to avoid in the pages while those clump of words with a high count that cluster around a central idea are the terms to select a type of page that interests the user.

After the analyzer 7-11, the set of matches are stored into memory 7-12 providing some basic statistics between two or more pages. A finite state machine 7-14 then is utilized to analyze the statistics that were generated by the comparison such that a new search expression term or statistical mask can be formulated. The results can also be presented to the user as data that can be a plot, graph, histogram, chart or using any mode of visualization. The processor 7-13 controls much of this activity although the couplings between the computer and individual blocks are not illustrated. After the search expression term or statistical mask 7-15 has been formulated, the new search terms or statistical mask are applied to the search engine 7-16 to generate a new list of links of the search result. Note that this particular search, the very first search is the conventional search which provides the user with a search result page of a number of links. Then after analyzing these links, the user introduces a more focused search by filling in the checkbox indicating that this type of webpage is of very much interest to the user. Thus, when a number of these pages that are of interest to the user have been identified, the analyzer performs the statistical analysis between these pages to hone in a new type of statistical mask.

In addition, many checkboxes can be introduced although they have not been shown. For example, one checkbox would indicate to the search engine that this type of page is of no interest. By analyzing the undesired page, one can then determine search terms that the desired webpages should avoid. In this case, the link statistics is used to avoid such pages. The statistical mask can be based on the interests of the user. If the user is interested in entertainment, then movie stars, rock tsars, music videos, music clips, etc. would be rates high on its user interest. If the user is interested in scientific papers in electrical engineering, then wafer, processing, CMOS, circuits, mixed-signal, etc. potentially would be topics.

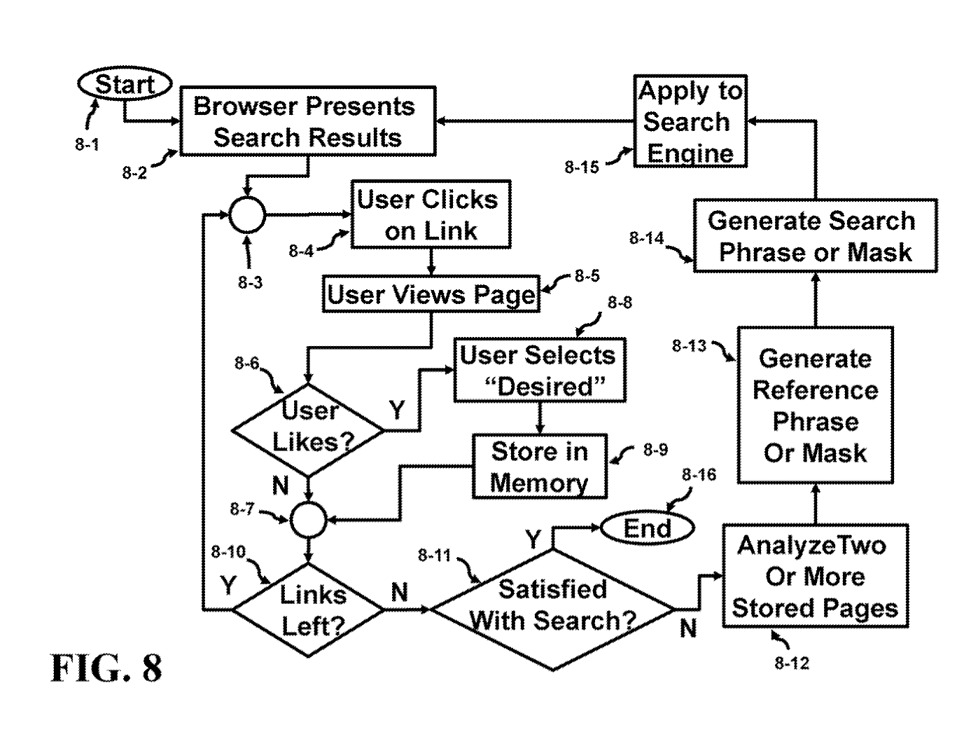

FIG. 8 depicts another flowchart embodiment of the inventive search where a comparison between two or more stored pages is made by the user. The flowchart starts at 8-1. A conventional search can be performed whereby the browser presents the search engine results 8-2. The user moves from the union 8-3 to where the user can click on links 8-4. The user clicks on desired links and views the pages 8-5 where upon the user moves into a decision block 8-6 to determine whether the user likes this type of page or dislikes it. If the page meets with the user's approval, the user selects desired as in block 8-8. The webpage is then stored in memory 8-9. The process proceeds to the union 8-7. On the other hand, if the user does not like the webpage, the user proceeds to the union 8-7. It is at this point, although not shown, the disliked or un-desired webpage can be used to generate statistics for the next search with regards to the topics that the user would like to avoid. After the union 8-7, the decision block 8-10 determines whether any potential links are left. If there are, proceed to union 8-3 and continue as before. On the other hand if no desired links are left, proceed to the next decision box 8-11 where the user determines whether this research is complete. If so, proceed to the end 8-16. If the user is not satisfied with the search and wants to continue searching, the two or more stored webpages are analyzed 8-12. The analyzer generates a reference statistical mask that determines some common sets of words and phrases 8-13. This information can be used to generate the search phrase or search mask 8-14. The search phrase at this point is automatically generated from the results of the comparison and the computational engine that may reside within the search engine itself or locally within the browser. The search mask can be created by the union or intersection of the individual statistical masks. In addition, forward links within the website can be used to gain a broader analysis and search phrase by comparing several pages of a website. (The search phrase is applied to the search engine 8-15 whereby new results are presented to the user for his perusal.)

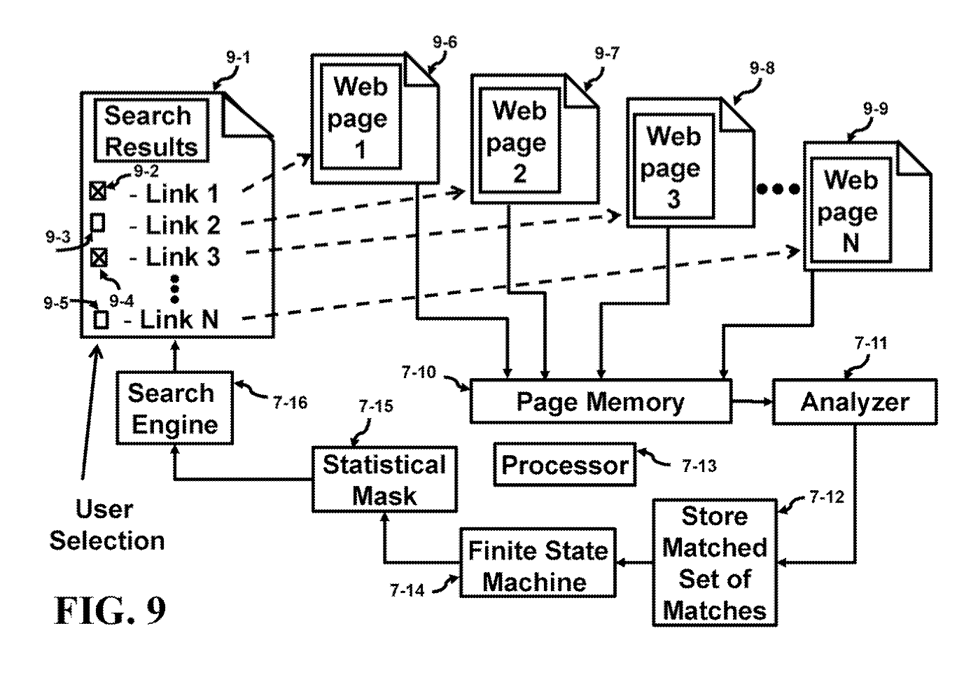

FIG. 9 is very similar to FIG. 7 with the exception that the check boxes 9-2 through 9-5 are presented to the user on the search results page 9-1. The search results page has a plurality of links and checkboxes. Some of these links can be selected by the user. And as shown, each of the plurality of links that are selected become user selected links. A memory to store a data content of webpages corresponding to the user selected links while an analyzer generates statistical results for the stored data content. The analyzer generates a set of matches between pages which is stored in the second memory. The display presents the statistical results of the stored data contents. A finite state machine determines a new statistical mask from the set of matches between pages. The check boxes 9-2 through 9-5 are filled by the user. For instance, link 1 9-2 and link 3 9-4 have been checked by the user as pages of further interest. However, in order to check these boxes, the user must first view the link on a browser 9-6 to 9-9. For example, when link 1 9-2 is clicked to present webpage 1 9-6; the user determines whether or not this webpage is of interest. If so, when the user returns to the search result page 9-1, the checkbox can be marked. The remaining links two through N can be viewed on the browser 9-7 through 9-9 and upon returning to the search result page 9-1, the corresponding checkboxes can be checked. Otherwise the operation of this block diagram is similar to the description given for the block diagram in FIG. 7.

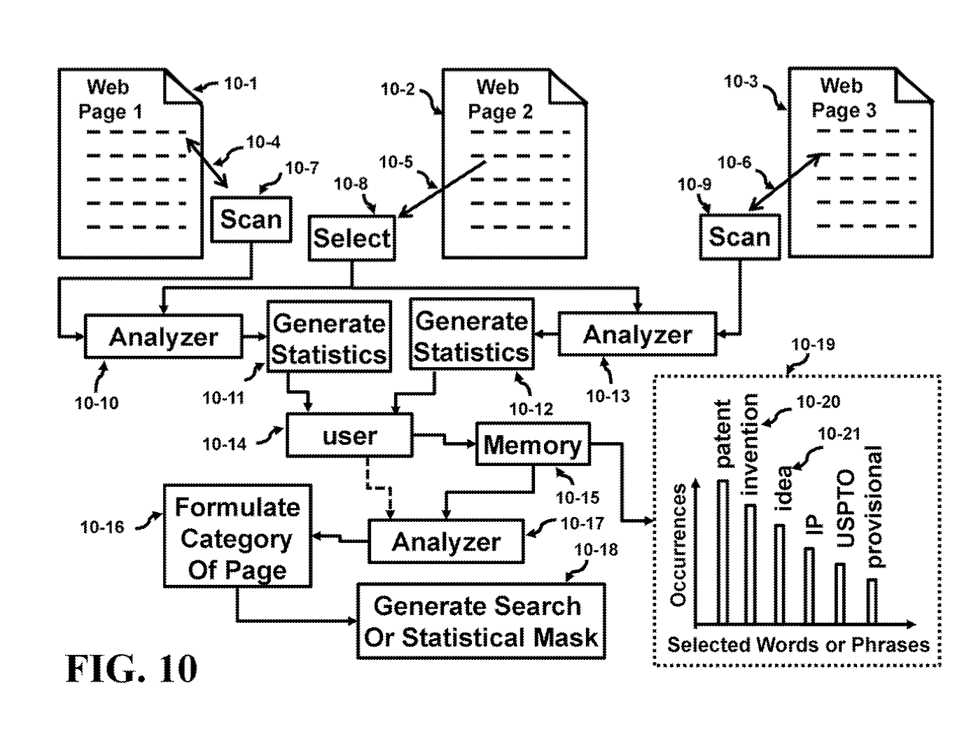

FIG. 10 provides a block description of how the comparisons are made and utilized to hone in on better search results. A first webpage has a selected data content while a second webpage has a scanned data content. Selected data content is the selection of search terms, phrases or masks within a webpage. Typically, this occurs once that page is opened and viewed for text, sounds, video, and other links. The scanned data content is a web page that will be opened and scanned for those particular search terms, phrases or masks. An analyzer analyses the selected data content with the scanned data content and a unit generates first statistical results between the selected data content with the scanned data content. A third webpage has a second scanned data content and a second analyzer analyses the selected data content with the second scanned data content. A second unit generates second statistical results between the selected data content with the second scanned data content. A user scans and compares the first statistical results with the second statistical results. A memory is used to store the statistical results. The user's information is also entered into the analyzer. An analyzer calculates a cross-statistical analysis and self-statistical analysis where the statistical analysis formulates the categories of the desired webpage. In addition, a new expression term or statistical mask can be determined from the statistical results between the different webpages. The display screen graphically displays the statistical results.

There are two forms of statistics used in the embodiment of this invention which are cross-statistical analysis and self-statistical analysis. The cross-statistical analysis compares two or more webpages for counts of common words or for a specific term or item. Furthermore, these are specified as nouns, verbs, adjectives, etc. Also, the webpages are analyzed for type of content, interest versus age group, grade level of sentence structure, downloadable content (scientific studies or experiments, sleazy, commercial, patents, etc.). All this information can be represented graphically (for example, see histogram in the dotted rectangle of FIG. 10). Self-statistical analysis, on the other hand, views a single webpage for counts of all words or for a specific term. Furthermore, these terms are specified as nouns, verbs, adjectives, etc. Also, the webpage is analyzed for the type of content, interest versus age group, grade level of sentence structure, downloadable content (scientific studies or experiments, sleazy, commercial, patents, etc.).

After the user had surfed the webpage results and filled in the check boxes of the desired pages, a comparison between the selected pages can be performed. Shown along the top are three web pages from a search results. (Search result link pages can be analyzed in a similar manner if these webpages are substituted with search results page.) These three web pages 10-1 through 10-3 were selected by checking the check boxes. Pages 10-1 and 10-3 are check marked to scan their link while page 10-2 serves as the seed or selected link. Once the user checks a box regarding a link, this link becomes a user selected link. There are several ways to make the comparison between webpages. This scan unit 10-7 is associated with the path 10-4 for the web page 1 10-1 while the scan unit 10-9 is associated with the path 10-6 for the web page 3 10-3. The select unit 10-8 center selects a particular term or phrase in the document of web page 2 10-2 via path 10-5 after this page had been analyzed at an earlier time. Meanwhile, the outer documents of web page 1 10-1 and of web page 3 10-3 are scanned for the data content that was provided by the selected page 10-2 by their corresponding scan boxes 10-7 and 10-9. The result of the scan 10-7 is analyzed by the analyzer 10-10 to user/statistical selected terms via the select box 10-8. The output of the analyzer 10-10 is applied to the generate statistics block 10-11. The analyzer 10-10 and the statistics block 10-11 together can be viewed as statistical results. Similarly, the result of the scan 10-9 is analyzed by the analyzer 10-13 to the same user selected terms from the select box 10-8. The output of the analyzer 10-13 is applied to the generate statistics block 10-12. Once the statistics are generated, a user 10-14 compares the two sets of statistics and sends information to the analyzer 10-17 via the dotted line to constrain the analyzer. The analyzer operates even if the user does not enter the information as now the analysis will be driven by the system and not by the user. The results of the first analysis are placed in memory 10-15. The user can compare or measure certain aspects between two different results.

A display screen can graphically display the statistical results. The graphical display can be viewed at any node generating statistics in FIG. 10. An example of one version of the statistical graphical output is provided in 10-19 in FIG. 10 which compares the scan of two different pages against selected terms of a third page. These selected terms are one version of the statistical mask. Along the X axis are the selected words and phrases applied to the select unit 10-8 while along the Y axes the number of occurrences in search results 1 10-1 and search results 3 10-3 are illustrated. The statistical tool is intelligent based tool using software, such as an applet, a dynamic link or plug-in and a computation unit (not depicted) to group similarly selected words as invention 10-20 or idea 10-21. The selection of patent can include words related to one of the search words or terms; for example, the undesired term shoe may be associated the word patent because of patent shoes. These undesired terms can be utilized to narrow the search and incorporating information into the next web search where the undesired terms are located and negated in the search. A memory is used to store the statistical results. The memory 10-15 applies the information to the analyzer 10-17 which is used to formulate the category of the page 10-16 and used to generate the search expression term or statistical mask 10-18 from the statistical results between the different webpages that can be used in further search analysis.

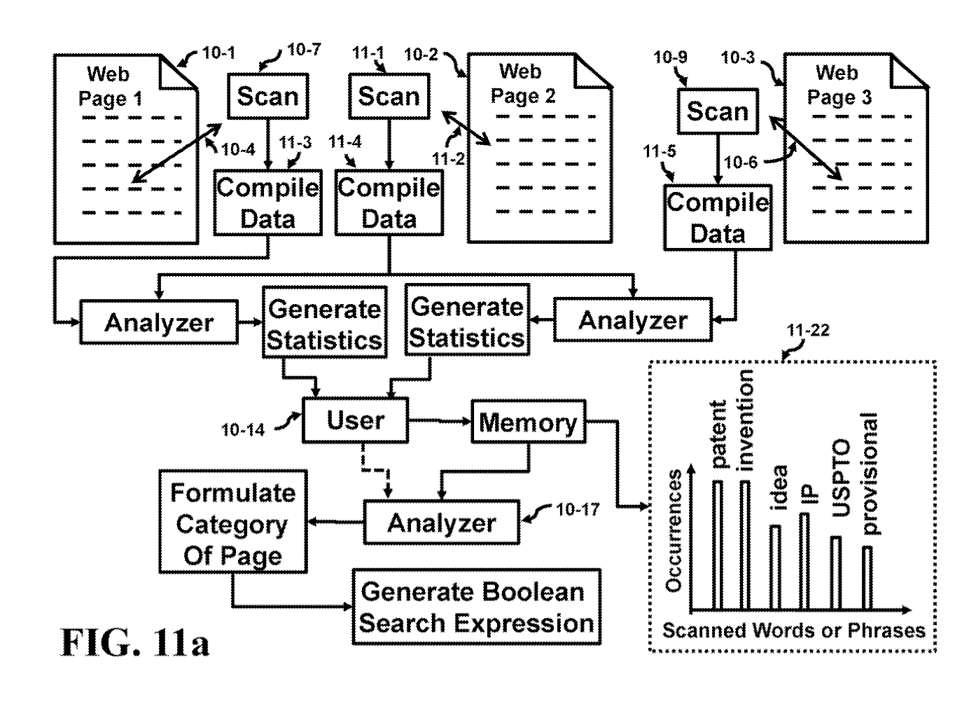

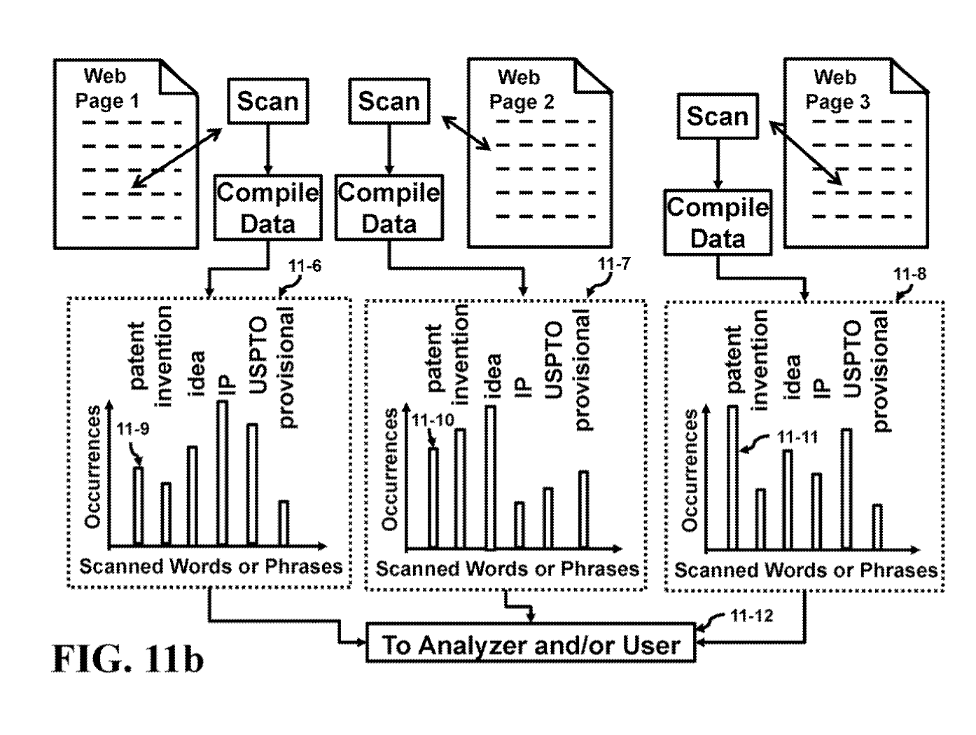

FIG. 11a illustrates another embodiment of the invention. A first webpage has a first scanned data content while a second webpage has a second scanned data content. An analyzer analyses the first scanned data content with the second scanned data content and a unit generates first statistical results between the first scanned data content and the second scanned data content. A second analyzer analyses the first scanned data content with third scanned data content. A second unit generates second statistical results between the first scanned data content with the third scanned data content. A user compares the first statistical results with the second statistical results and sends their selection to the third analyzer. A memory is used to store the statistical results. The third analyzer calculates a cross-statistical analysis and self-statistical analysis where the statistical analysis formulates the categories of the desired webpage. In addition, a new expression term or statistical mask can be determined from the statistical results between the different webpages. The display screen graphically displays the statistical results.

FIG. 11a is very similar to FIG. 10. The select box 10-8 has been replaced by the scanned data content 11-1. Each scan is user specified. The user can set bounds on the search terms from a specified search term or all common words and phrases in the scanned page. This information provides a portion of the data content of a webpage. This embodiment allows the user to determine how strongly tied the scanned data content of two different webpages are to each other. Web page 2 10-2 are associated with the path 11-2 and the scanned data content 11-1. In this case, the scans of the three links are done independently of one another where the scan results are compiled in blocks 11-3, 11-4 and 11-5 and analyzed against another result in an analyzer. This information or data is applied to the analyzer to generate statistics. Although not illustrated, the “compile data” can be viewed in graphical and other forms for evaluation. Each compile data block compares webpages, generates statistics, compares the scan, and stores results into memory for viewing or storing. The results are analyzed by the user to generate word expressions based on the previous search terms or the system can generate the statistical mask based on the statistical analysis of the previous webpages. The outputs of the analyzer are stored in memory to be processed graphically and/or to generate new search terms. One extreme is to use brute force to counting all words in each webpage; at the other extreme is the search for one term. The histogram 11-22 provides the number of occurrences of several selected words and can also be used as a seed or mask for the next search.

The analyzer and/or user 10-14 generates a set of matches between pages while the third analyzer 10-17 continues looking for features in the links, such as, those that are favorite websites, topics, news articles, youtube video, etc. The analyzers calculate a cross-statistical analysis and self-statistical analysis. Cross-analysis is the statistical analysis between different links while self-statistical is within the same link. The statistical analysis formulates the categories of the desired webpage by analyzing the contents of the memory. In addition, a statistical mask can be determined from the statistical results between the different webpages. Finally, a display screen graphically displays the statistical results stored in the memory.

FIG. 11b illustrates another embodiment that analyzes the page statistics. Each webpage is scanned for the specified term from the user or for all search, terms then the data is complied. The output of the compiled data blocks 11-6 through 11-8 is shown graphically as histograms. After a webpage is loaded, complicated search terms can be used to search and analyze each individual webpage. The word counts of the terms patent, invention, idea, IP, USPTO and provisional are presented for the three different webpages. An individual webpage can be analyzed separately, results viewed on a display screen, and then the results of several pages can be analyzed for further data. For example, the word patent has various occurrences as indicated by 11-9 through 11-11. These results stored in memory (not shown) and are applied to the analyzer and for user 11-12. The analyzer and/or user can perform many functions. Some include the selection of the best webpage result, generating additional search terms, searching for terms that are not desired, performing statistical analysis, etc.

Another scan in FIG. 11b may include the count of all common terms which can be used by an analyzer to determine a better search term or the selection of a high ranking page. A plurality of webpages are used in the analysis where each webpage has is scanned for data content. A compile data block providing statistical results of the scanned data content of each webpage while an analyzer combines all individual statistical results into one combined statistical result and calculates a cross-statistical analysis and self-statistical analysis. The statistical analysis formulates the categories of the desired webpage. The display present's the individual statistical results of the webpages, presents the combined statistical results from the analyzer, and graphically displays the statistical results that can be shown in a pop-up window. The analyzer can perform many functions. Some include the selection of the analysis of grouping of terms, searching for terms that are not desired, performing statistical analysis, etc.

So far, although results of search pages presented lists of links pointing to webpages. FIG. 11c shows a chart 11-13 presenting one way of viewing the search results. Shown as numbers in circles are the three webpages in FIG. 11b that were selected by the user. A solid line boundary 11-15 surrounds each of the webpages. Un-common terms between the webpages are more distant from each another on this chart 11-13. For instance, 11-14 indicates a search result that is common to webpage 2 but less common to webpage 1 or 3. The dotted circle in the center 11-16 indicates those results that are closer to each another as illustrated by the three dots. These dots represent a grouping of terms or words that is shared between the websites. FIG. 11d illustrates a histogram of these search results within the dotted circle 11-16 that are segregated into groups after being extracted from the viewed links. The terms in the histogram 11-17 are used for future searches while those terms in the histogram 11-18 and 11-19 are terms that are to be avoided in future searches. In other words, the terms within 11-18 and 11-19 are terms that one desires not to have in future documents that have been searched by the search engine. This forms a second statistical mask that is used to prevent those matching pages from being presented to the user in a future search result. An example of the histogram is provided in FIG. 11e, where the distribution of words or phrases 11-20 or pertain to patents and inventions and ideas. The second group of words and 11-21 are words the user would like to avoid such as pocketbook, leather and shoes which could be patented but is not the patent that the user is interested.

Finally, a distribution similar to the distribution 11-20 provides the user with an idea of how often these terms are used on the page and is used in the statistical mask. By providing the user a count of these terms or the statistical mask itself, the user can determine how important this webpage may be for other search purposes that may interest the user. For example, the user is investigating a website and wants to perform a search on that website for a particular term or set of terms. The count provides to the user with a sense of how important their desired terms are to the webpage. This process is a search within a search. The first search found the webpage, while the count provides a second search of terms within those webpages.

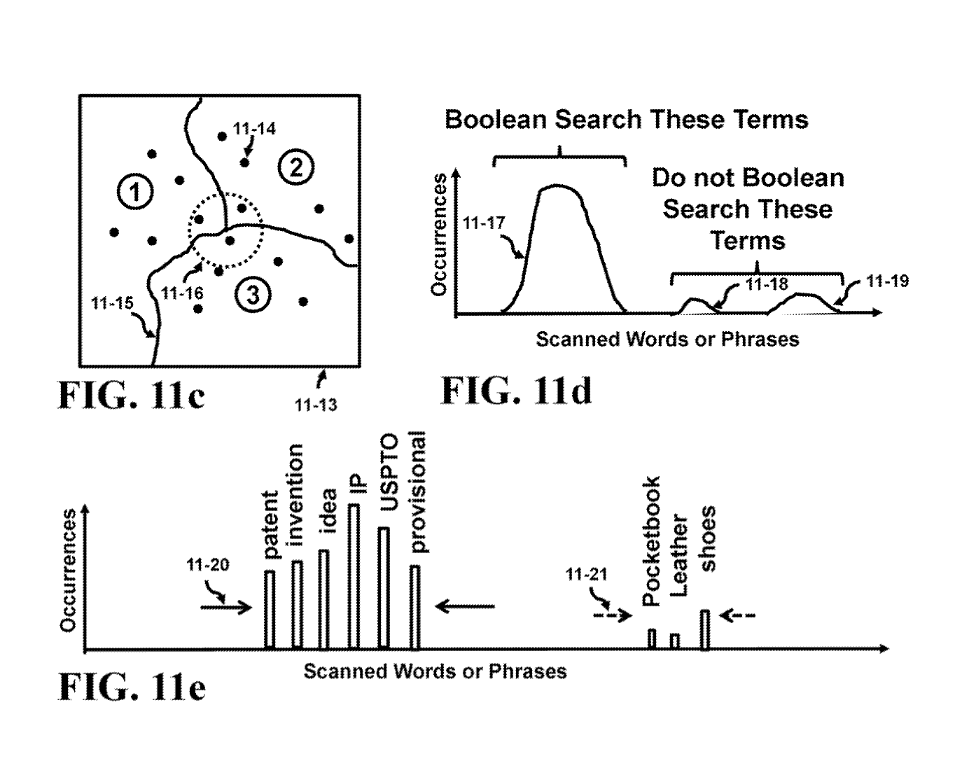

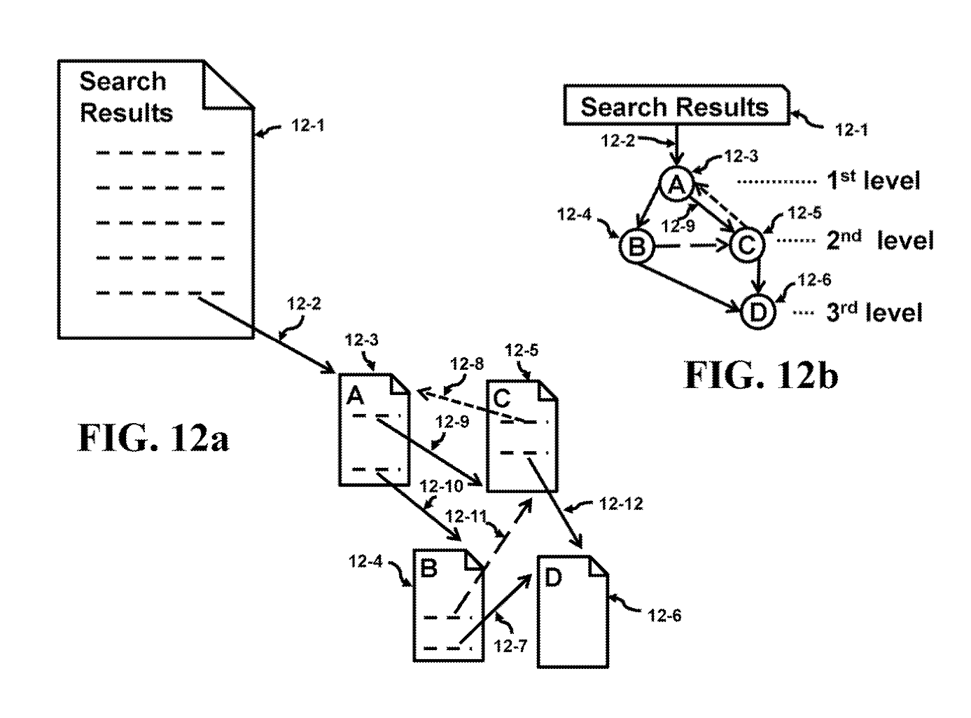

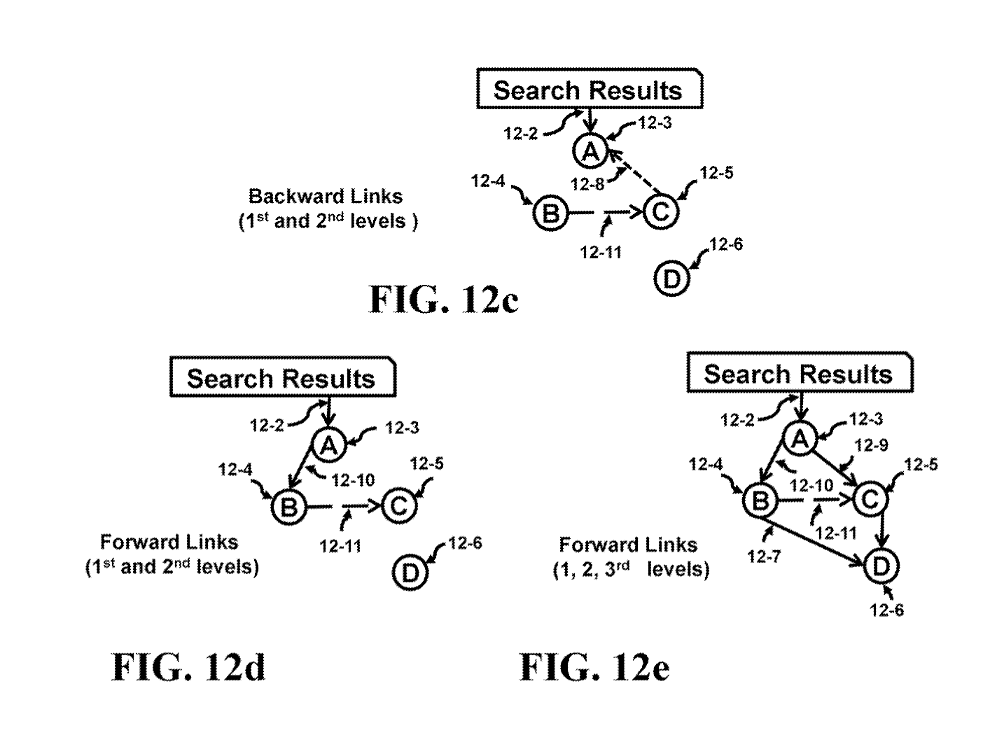

FIG. 12a presents a node net of the links of search results and the links of several levels of forward and backward links in a given search. The search results can include pages from only one website, pages from different websites, or combination of the two. For example, search results page 12-1 provides a link with a forward path 12-2. The search result points to page A 12-3 which itself has two forward links 12-9 and 12-10 pointing to page C 12-5 and page B 12-4. Page C 12-5 has a forward link 12-12 that points the page D 12-6 while page B 12-4 has two links; the first link is a horizontal link 12-11 points the page C 12-5 while the second link is a forward link 12-7 points the page D 12-6. There is one backward link in the FIG. 12a, the link 12-8 starts at page C 12-5 and points to page A 12-3. A graphical presentation is illustrated in FIG. 12b, where the links are associated with the level of depth. For example, node A is at the first level, nodes B and C are at the second level and node D is at the third level. The level's indicate how many links one must pass through to get to that particular node from the initial search results page. For example, node C can be reached from the search results page 12-1 by using the minimum of two links 12-2 and 12-9. Node D is at a third level because a minimum of three forward links is required to reach node D. The mapping of the node net provided in FIG. 12b would be an example of the mapping of the pages of the home page website and some of its sub-directories. If the node net is split between two or more base websites, then the likelihood of these base websites being comparable improves.

These nodal graphical descriptions or presentations can then be pruned and in various levels of degree. In FIG. 12c, all of the backward links are illustrated. Even though the previously horizontal link 12-11 remains on the second level it does provide a link 12-11 for node B 12-4 to get to node C 12-5 and for node C to go on a backwards link 12-8 to node A 12-3. The backwards link only affects the second levels of this graphical description. FIG. 12d and FIG. 12e illustrate the forward links. In FIG. 12d, the first and second levels are illustrated where node A 12-3 has a link 12-10 to node B 12-4 and node B has a horizontal link 12-11 to node C 12-5. In addition, in FIG. 12e, node A 12-3 has a link 12-9 to node C 12-5. Three levels of forward links are illustrated in FIG. 12e. Node B 12-2 has a link 12-7 to node D 12-6 and node C 12-5 has a link 12-12 to node D 12-6.

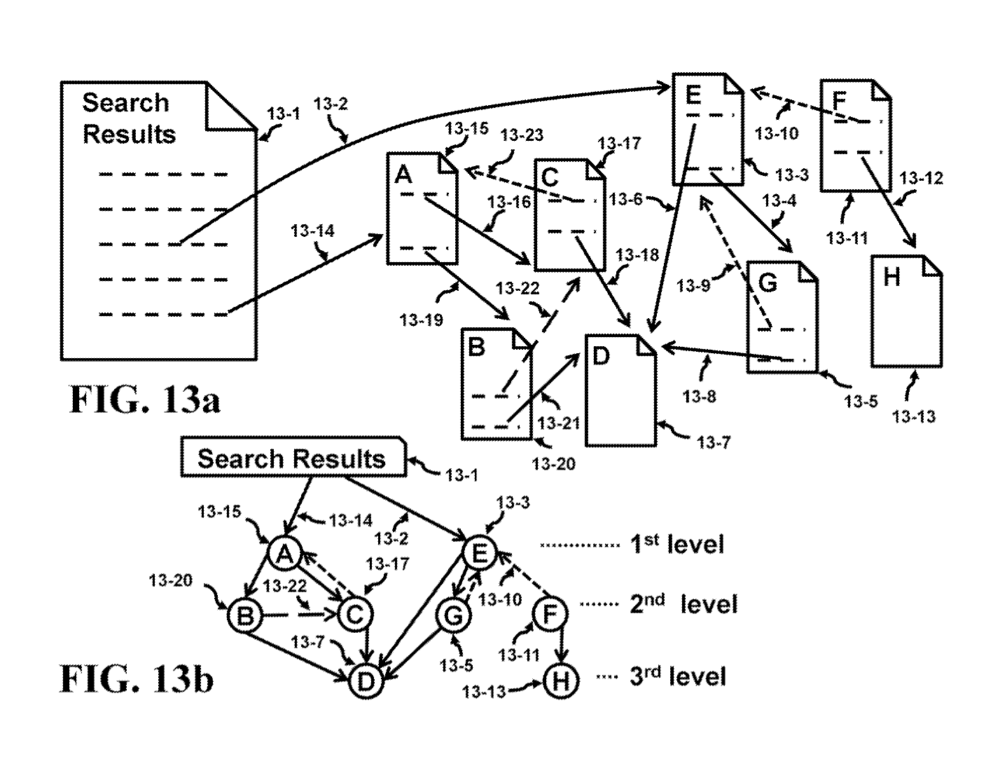

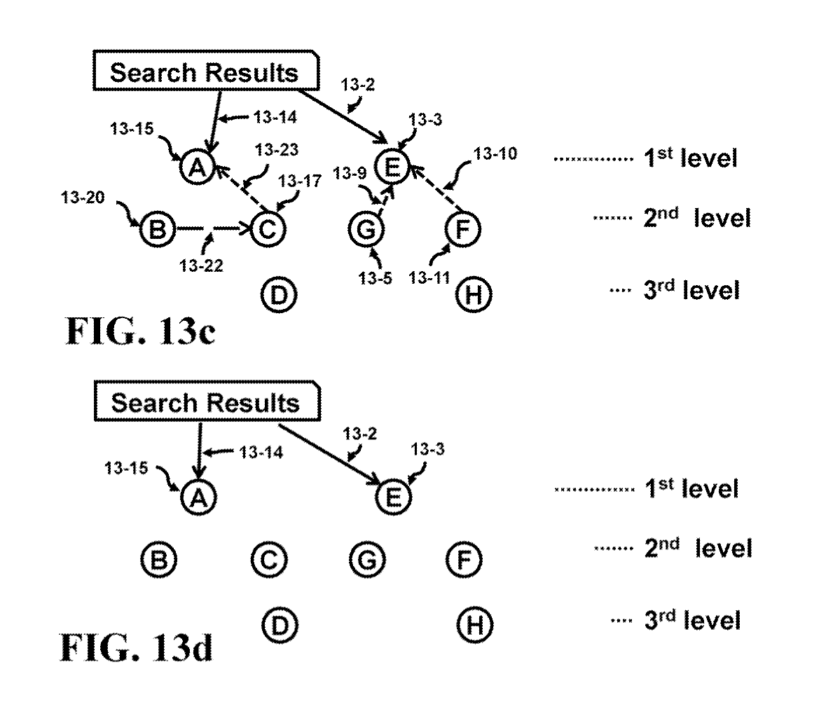

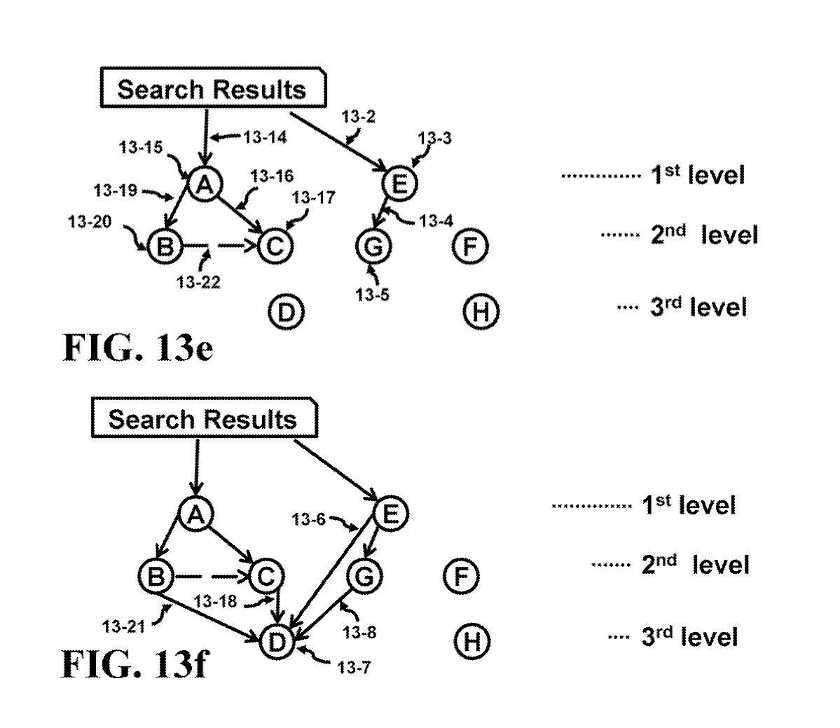

FIG. 13a presents another set of links for a search results page and the links of several levels of forward and backward links in a given search. Search results 13-1 provide a link with two forward paths 13-2 and 13-14. The search results point to page E 13-3 which itself has two forward links 13-4 and 13-6 pointing to page G 13-5 and page D 13-7. Page F 13-5 has a backward link 13-10 that points the page E 13-3 while page F 13-11 has one forward link 13-12. Page G 13-5 has a backwards link 13-9 and a forward link 13-8 which points the page D 13-7. Page A 13-15 pointed to by path 13-14 has two forward links 13-16 pointing to page C 13-17 and a forward link 13-19 pointing to page B 13-20. There is a backward link 13-23 starts at page C 13-17 and points to page A 13-15. Page C has a forward link 13-18 to page D 13-7 while page B 13-20 has a forward link 13-21 pointing to page D 13-7 and a horizontal link 13-22 pointing to page C 13-17. Page D is common to both forward paths 13-2 and 13-14. This page cross-references the search terms from different forward paths and may indicate particular relationships between the two forward paths. If the set of links is encompassed within one base website and its sub-directories, this page may provide a commonality data between the search terms. If in the set of links, the forward paths 13-2 and 13-14 are encompassed within different base website and their sub-directories (within the one base website), this page may indicate that these websites share a common interest.

A nodal graphical presentation of FIG. 13a is illustrated in FIG. 13b, where the links are associated with the level of depth. For example, node A and node E are at the first level, nodes B, C, G and F are at the second level and nodes D and H are at the third level. The levels indicate how many links one must pass through to get to that particular node. Node C can be reached from the search results page 13-1 by using the minimum of two links 13-14 and 13-16. Node D is at the third level because a minimum of three forward links is required to reach node D.

The nodal graphical description or presentation can then be pruned and in various levels of degree. In FIG. 13c, all of the backward links are illustrated. Even though the previously horizontal link 13-22 remains on the second level it does provide a link 13-22 for node B 13-20 to get to node C 13-17 and for node C to go on a backwards link 13-23 to node A 13-15. The backwards link only affects the second levels of this graphical description. Node G 13-5 and node F 13-11 both have backwards links 13-9 and 13-10 back to node E 13-3. Nodes D and H are available only on level 3.

FIG. 13d through FIG. 13f illustrates the forward links. In FIG. 13d, the first level are illustrated where node. A 13-15 has a link 13-14 and node E 13-3 has link 13-2. FIG. 13e shows the second level where node B 13-20 is coupled by a forward link 13-19 from node A 13-15 and node C 13-17 is coupled by the horizontal link 13-22 from node B 13-20 and the forward link 13-16 from node A 13-15 to node C 13-17. Node E has a forward link 13-4 to node G 13-5. The third level is indicated in FIG. 13f. Node D 13-7 is coupled by a forward link 13-21 from node B and a forward link 13-18 from node C. Node D 13-7 is also coupled by a forward link 13-6 from node E and a forward link 13-8 from node G. Nodes F and node H are uncoupled.

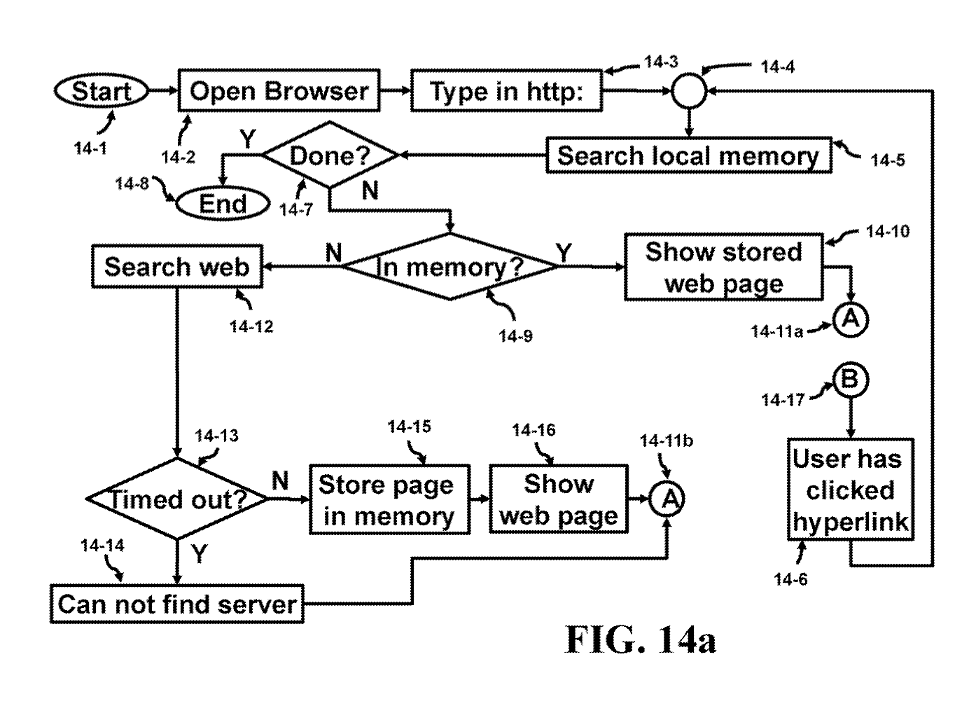

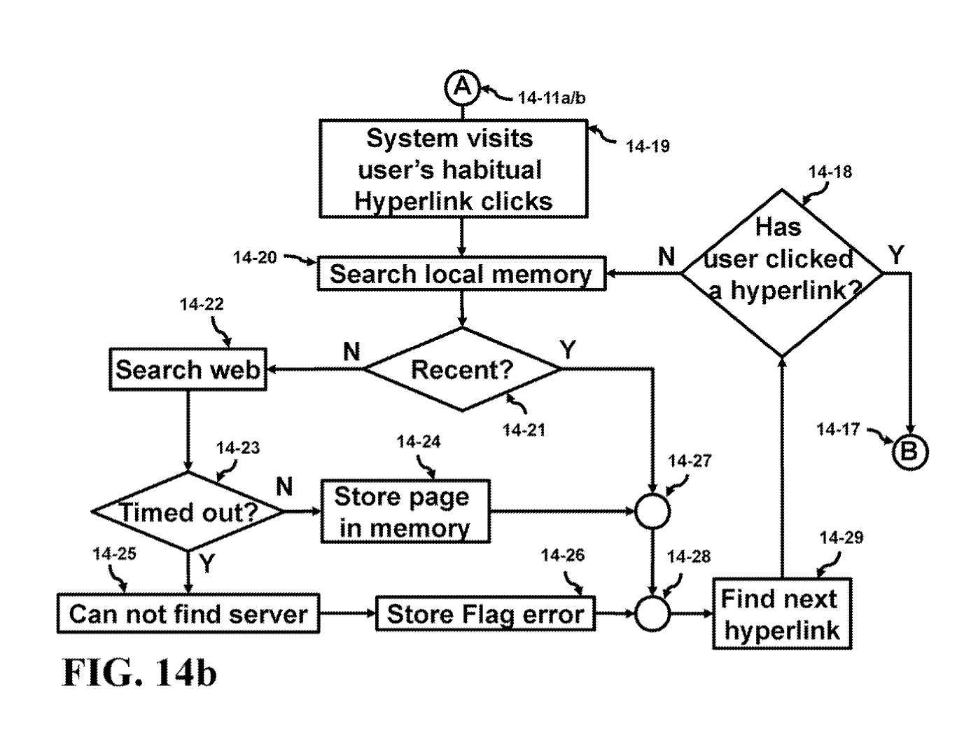

FIG. 14a illustrates a flowchart depicting local memory being used to store previously loaded webpages assuming if the path between A 14-11a is directly connected to B 14-17 and A 14-11b is directly connected to B 14-17. At start 14-1, the browser is open 14-2, an http address in typed 14-3. The local memory is searched for the site 14-5 and if done 14-7 move to end 14-8. Otherwise if the web address is not in memory, search the web 14-12 and if not timed out 14-13, store page into memory 14-15 and display page 14-16 then move to A 14-11b. If timed out 14-13 is true, state cannot find server and move to A 14-11a. If the web address is in memory 14-9, show the webpage and move to A 14-11a. Assume A is connected to B, then if the user clicks on a link 14-6, the flow returns to search local memory 14-5.

FIG. 14b depicts the inventive embodiment that replaces the short and couples A to B with the depicted flowchart. At A 14-11a/b, the system visits the user's habitual hyperlink clicks 14-19. This can be searched for in the local memory 14-20. The data is provided by the user spending time on each webpage, number of times the user visited address, the user selecting particular categories of topic for each clicked link, etc. The system determines which pages are visited habitually. For example, if the site is viewed every day or if site is viewed several times a day. The more often a page is accessed, then that page is updated sooner than the remaining stored web addresses. After searching the local memory 14-20, is the web address data recent 14-21? If the data is old, search the web 14-22 and if not timed out, store page in memory 14-24. Move to union 14-27 then to union 14-28 and then to find the next hyperlink 14-29, if user has not clicked a hyperlink 14-18, then continue updating the local memory with the most recent web address data. The most recent period can be set by the user to be 1 second, 1 hour, 1 day or any portion of time. If a web search is timed out 14-23, the system can mark this site as not being found by the server 14-25, store a flag 14-26 to prevent accessing this address and move to union 14-28. If user clicks a hyperlink 14-18, then exit this sub-routine via B 14-17 and see FIG. 14a. The local memory is searched 14-5 for the link clicked by the user.

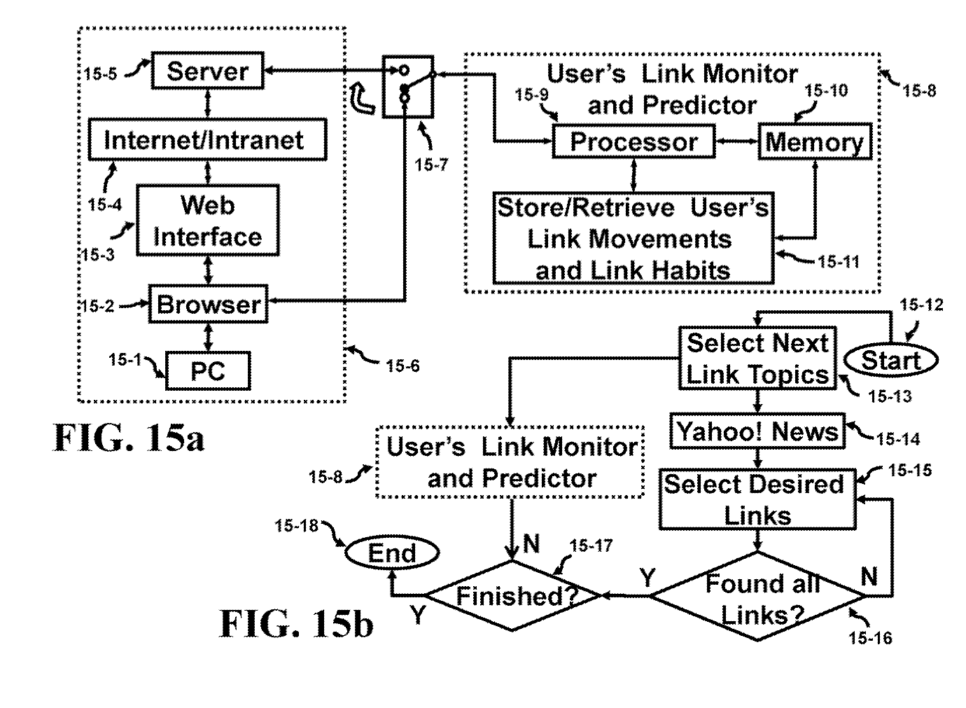

FIG. 15a presents a path from the PC 15-1, to the browser 15-2, the web interface 15-3, the Internet/Intranet (or the network) 15-4 and the server 15-5 and a second path from the PC to memory 15-10 when allowed by the switch 15-7. When the address is new and not in the memory, the server provides the data for the server hosting the website. However, when the PC requests the same address at a later point in time, the browser 15-2 re-routes the path to the link monitor and predictor unit 15-8. The link monitor and predictor unit 15-8 uses the processor 15-9 to calculate or determine the links, the user's movements on a website and the user's link habits. The links are stored and retrieved, as are the link movements and link habits of the user. The switch 15-7 transfers the path to the link monitor and predictor unit 15-8 that comprises a processor 15-9, a memory 15-10 and a store and retrieve link memory 15-11. The switch 15-7 uses the processor 15-9 to monitor the system. This allows the switch to be dependent on the user activity and re-route the switch connectivity accordingly.

The memory of the link monitor and predictor unit stores all data associated with storage and retrieval of links, link movements and link habits. Any link entered by a user surfing the web is stored in memory. The processor of the link monitor and predictor unit is programmed to perform all calculate associated with storage and retrieval of links, link movements and link habits. The processor monitors the user activity, controls the switch, monitors the timestamp of each stored link and refreshes those links that are older first. The processor also monitors the timestamp of each stored link and retrieves the recently updated links.

The user's movements within a new website are stored. Also, by monitoring the contents of the Headings, Title page, logo, etc. within a page, the system determines the link habits of the user (how much time is spent on a link, what types of links appear to be interesting, any categories not viewed?). The switch and processor monitors user activity and determines that the user activity is inactive upstream. The upstream direction is from the PC to the server and is inactive in this direction. The switch then couples the link monitor and predictor unit to the server to refresh the stored links. And when the user activity is active upstream, the switch couples the link monitor and predictor unit to the browser to search and retrieve any stored links matching a desired link of the user. The timestamp of the update is included in the data associated with the link. This timestamp can be used to check on the age of the link. If the link is not stored, the user's link monitor and predictor stores the link. The link and their ratings, importance, interest, and content are stored and updated regularly. The update is done when the power is applied to the PC and can be monitored continuously or at certain time intervals afterwards. When the user who is monitoring the PC 15-1 decides to view an earlier website, the link memory and predictor 15-8 quickly provides the most recent data on the website. Instead of waiting for the site to download from a server, the data is extracted from local memory 15-10 and is presented to the user.

FIG. 15b presents how the link monitor and predictor unit 15-8 monitors a new link and its sub-directories. The sub-directories are those pages within a single website starting at the homepage. These links, typically, point to the 1^{st}, 2^{nd}, 3^{rd} level of the home page. After start 15-12, the user selects a topic 15-13 or address, which happens to be Yahoo! News 15-14. The user selects the desired links 15-15 after finding the links 15-16, while the link monitor 15-8 is observing, tracking and analyzing the user's clicks. For example, since “sports” or “weather” categories are never clicked, the link monitor and predictor perceives a lack of interest in these areas. Similarly, when the user was on an earlier news website (www.foxnews.com), the link monitor and predictor unit uses this information on the earlier news to extract similar type categories on the current news site. When the user is finished 15-17, the program exits 15-18.

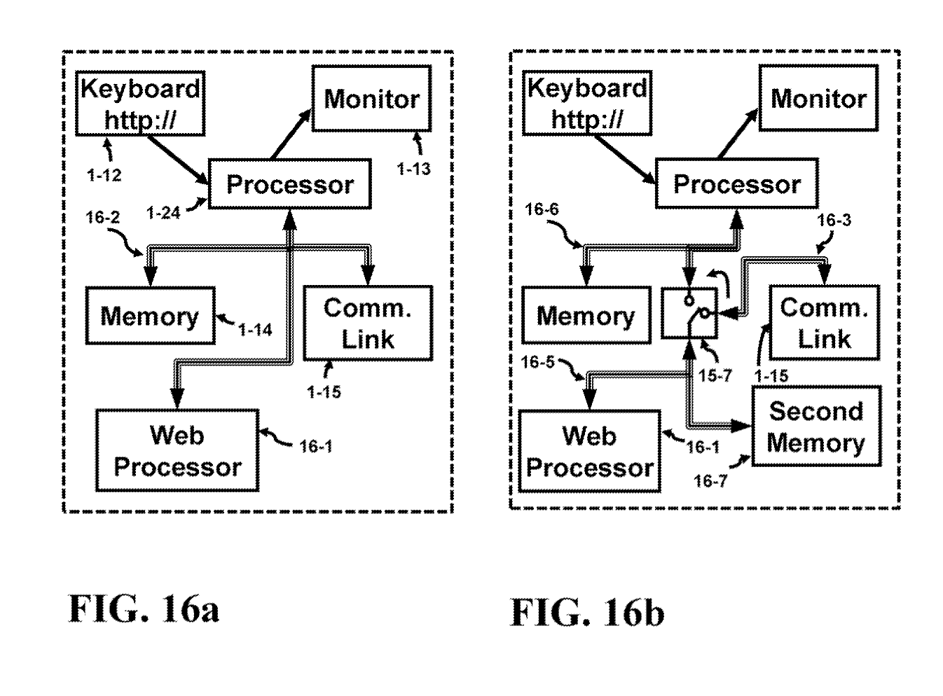

FIG. 16a illustrates a block diagram of a portable unit. A keyboard 1-12, a monitor 1-13, processor 1-24 and bus 16-2. The bus couples the processor to the memory 1-14, the communication link 1-15 and the web processor 16-1. FIG. 16b depicts the insertion of the switch 15-7 which partitions the previous bus 16-2 into three bus components 16-3, 16-5 and 16-6. The communications link 1-15 uses the web processor 16-1 to fill the second memory 16-7 as requested by the link monitor and predictor unit (not shown). When the user requests this page, the switch 16-4 changes state and couples the processor to the second memory 16-7. The contents are displayed on the PC's display.

Finally, it is understood that the above description is only illustrative of the principles of the current invention. It is understood that the various embodiments of the invention, although different, are not mutually exclusive. In accordance with these principles, those skilled in the art may devise numerous modifications without departing from the spirit and scope of the invention. The network can have at least one processor comprising a CPU (Central Processing Unit), microprocessor, multi-core-processor, DSP, a front end processor, or a co-processor. These processors are used to provide the full system requirements to manipulate the signals as required. All of the supporting elements to operate these processors (memory, disks, monitors, keyboards, power supplies, etc), although not necessarily shown, are known by those skilled in the art for the operation of the entire system.

What is claimed is:

1. An apparatus comprising:
a browser coupled to a server;
a link monitor and predictor unit that stores and retrieves links, link movements and link habits; and
a switch dependent on user activity, whereby
when the user activity is inactive upstream, the switch couples the server to the link monitor and predictor unit to refresh any stored links in the link monitor and predictor unit.

2. The apparatus of claim 1, further comprising:
the browser resides on a PC;
the PC coupled to a web interface;
the web interface coupled to a network;
the network coupled to the server.

3. The apparatus of claim 1, wherein
a memory of the link monitor and predictor unit stores all data associated with storage and retrieval of links, link movements and link habits.

4. The apparatus of claim 1, wherein
any new link entered by a user surfing the web is stored in memory.

5. The apparatus of claim 1, wherein
a processor of the link monitor and predictor unit is programmed to perform all calculations associated with storage and retrieval of links, link movements and link habits.

6. The apparatus of claim 5, wherein
the processor monitors the user activity and controls the switch.

7. The apparatus of claim 5, wherein
the processor monitors a timestamp of each stored link and refreshes older links first.

8. An apparatus comprising:
a browser coupled to a server;
a link monitor and predictor unit that stores and retrieves, links, link movements and link habits; and
a switch dependent on user activity, whereby
when the user activity is active upstream, the switch couples the browser to the link monitor and predictor unit to search and retrieve any links matching a desired link entered by a user.

9. The apparatus of claim 8, further comprising:
the browser resides on a PC;
the PC coupled to a web interface;
the web interface coupled to a network;
the network coupled to the server.

10. The apparatus of claim 8, wherein
a memory of the link monitor and predictor unit stores all data associated with storage and retrieval of links, link movements and link habits.

11. The apparatus of claim 8, wherein
any new link entered by a user surfing the web is stored in memory.

12. The apparatus of claim 8, wherein
a processor of the link monitor and predictor unit is programmed to perform all calculations associated with storage and retrieval of links, link movements and link habits.

13. The apparatus of claim 12, wherein
the processor monitors the user activity and controls the switch.

14. The apparatus of claim 12, wherein
the processor monitors a timestamp of each stored link and retrieves the recently updated links.

15. An apparatus comprising:
a browser coupled to a server;
a new website; and
a link monitor and predictor unit that stores any new links, link movements and link habits as a user views the new website.

16. The apparatus of claim 15, further comprising:
the browser resides on a PC;
the PC coupled to a web interface;
the web interface coupled to a network;
the network coupled to the server.

17. The apparatus of claim 15, wherein
a memory of the link monitor and predictor unit stores all data associated with storage and retrieval of links, link movements and link habits.

18. The apparatus of claim 15, wherein
any new link entered by a user surfing the web is stored in memory.

19. The apparatus of claim 15, wherein
a processor of the link monitor and predictor unit is programmed to perform all calculations associated with storage and retrieval of links, link movements and link habits.

20. The apparatus of claim 19, wherein
the processor monitors the user activity and controls the switch.
